(19) United States
(12) Patent Application Publication
(10) Pub. No.: US 2015/0346938 A1
(43) Pub. Date: Dec. 3, 2015

(54) Variable Data Video

(71) Applicant: Visible Spectrum, Inc., Chicago, IL (US)

(72) Inventors: Baron Gerhardt, Wonder Lake, IL (US); John Malec, Chicago, IL (US); Sam Melton, Aurora, IL (US); Aaron Taylor, Palos Hills, IL (US)

(21) Appl. No.: 14/821,246

(22) Filed: Aug. 7, 2015

Related U.S. Application Data
(63) Continuation-in-part of application No. 13/758,109, filed on Feb. 4, 2013, now Pat. No. 9,110,572.

(51) Int. Cl. G06F 3/0484; H04L 29/08

(52) U.S. Cl. CPC G06F 3/0484; H04L 67/06

(57) ABSTRACT

A computing device is configured to provide over a network an ability to create variable data custom multi-media files. In one example, a computing device imports a data file including an array of output files over a network. The computing device provides a user interface for a requesting computing device to manipulate a video template with layers are associated with display of an output during. The computing device receives a request to assign columns from the array to layers of the timeline. The computing device processes the data file and the requests to render variable data custom multi-media files, and makes them available to the requesting computer device. The variable data custom multi-media files display output over the time periods associated with the timeline layers that is based on the assigned array of output files.

### RELATED APPLICATIONS

This application is a continuation in part of U.S. patent application Ser. No. 13/758,109 (“the '109 application”), filed on Feb. 4, 2013, which will issue on Aug. 18, 2015 as U.S. Pat. No. 9,110,572, and which is hereby incorporated by reference in its entirety.

### COPYRIGHT NOTICE

The computer program listings portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### COMPUTER PROGRAM LISTING APPENDIX

Computer program listings written in JavaScript and PHP, co-filed with EFS-Web, and identified as follows are incorporated by reference as if fully re-written herein:

datasource_builder_js.txt (65 kilobytes),

automation_purchase.txt (1 kilobyte),

automation_services.txt (15 kilobytes),

automation_datafetcher_tester.txt (23 kilobytes),

automation_datafetcher.txt (23 kilobytes), and

datasource_builder.txt (9 kilobytes).

The computer listings submitted with the '109 application are also herein incorporated by reference in their entireties.

### TECHNICAL FIELD

The invention relates generally to network available video editing technology and, more specifically to network based video creation.

### BACKGROUND

It is generally known that advertising products and services can result in increased sales for the company or products featured in the advertising. Advertising can come in a variety of forms including print ads, static or near-static on-line advertising, or video based advertising. Because video based advertising can convey more information and many situations video advertising can be therefor preferred.

Producing a video advertisement, however, can be quite pricey. Equipment for producing the video must be purchased or rented and software for combining together the various aspects of a video can also be expensive. In particular, where modern advertising generally includes various graphics and video effects to catch the intended audience's attention. Such effects can be difficult to integrate into a video form.

Various methods are known for creating print advertisement using a computer based editing approach. Such systems for creating print advertising, however, cannot handle the complexities involved with combining various video elements desired for modern advertising.

### SUMMARY

Generally speaking and pursuant to these various embodiments, a computing device is configured to provide over a network an ability to create a 2.5D full motion custom multi-media file. The term “2.5D” refers to two and a half dimensional video or two dimensional video that shows a series of images that gives the impression of watching a three dimensional video. In one example, a computing device makes available to a user a plurality of stored video templates into which a user may insert custom video, photos, and/or text. The computing device provides a low resolution preview of the custom video to the user over the network connection. The user then has the ability to edit the low resolution custom video by manipulating the template prior to finalization. The computing device receives signals indicating purchase or licensing credentials and in response to receiving such credentials, finalizes and delivers a 2.5D video for the user. So configured, a user can relatively cheaply and quickly create video content such as an advertisement having modern visual features such as 2.5D video in a cost efficient and timely manner. These and other benefits may become clear upon making further review and study of the following detailed description.

In some embodiments, a computing device is configured to provide over a network an ability to create variable data custom multi-media files. In one example, a computing device imports a data file over a network that includes an array of output files. The computing device provides a user interface for a requesting computing device to manipulate a video template that includes at least one layer on a timeline. The timeline layers are associated with display of an output (e.g., a graphic such as an image, text or video file, an audio file, or combinations thereof) during a time period of the variable data custom multi-media files. The computing device also receives a request (e.g., from the requesting computing device) to assign a first column from the array of output files to the layers of the timeline. The computing device processes the data file and the requests to generate and/or render variable data custom multi-media files. The computing device then makes the rendered variable data custom multi-media files available to the requesting computer device. Each of the variable data custom multi-media files displays an output over the time periods associated with the timeline layers that is based (at least in part) on individual output files from the assigned array of output files. In this manner, at least some of the variable data custom multi-media files will display a different output during those time periods of playback.

### BRIEF DESCRIPTION OF THE DRAWINGS

The above needs are at least partially met through provision of the network based video creation described in the following detailed description, particularly when studied in conjunction with the drawings, wherein:

FIG. 1 comprises a flow diagram of an example method of providing the ability to create a 2.5D full motion custom multi-media file over a network connection as configured in accordance with various embodiments of the invention;

FIG. 2 comprises an illustration of an example user interface for previewing and editing video as configured in accordance with various embodiments of the invention;

FIG. 3 comprises a further illustration of the example user interface of FIG. 2;

FIG. 4 comprises a further illustration of the example user interface of FIG. 2;

FIG. 5 comprises a block diagram of a system overview for an example approach to implementing a method such as that of FIG. 1, as configured in accordance with various embodiments of the invention;

FIG. 6 comprises a block diagram of an example media ingest process as configured in accordance with various embodiments of the invention;

FIG. 7 comprises a block diagram of an example ingest processing process as configured in accordance with various embodiments of the invention;

FIG. 8 comprises a block diagram of an example quality check and corrections process as configured in accordance with various embodiments of the invention;

FIG. 9 comprises a block diagram of an example process to generate preview elements as configured in accordance with various embodiments of the invention;

FIG. 10 comprises a block diagram of an example content renderer as configured in accordance with various embodiments of the invention;

FIG. 11 comprises a block diagram of an example bulk content generator as configured in accordance with various embodiments of the invention;

FIG. 12 comprises a block diagram of an example process to facilitate external medial purchased as configured in accordance with various embodiments of the invention; and

FIG. 13 comprises a block diagram of an example search aggregator as configured in accordance with various embodiments of the invention.

FIG. 14 comprises a flow diagram of an example method of providing the ability to generate variable data custom multi-media files over a network in accordance with various embodiments of the invention;

FIG. 15 comprises an illustration of an example user interface for importing a data file to use to generate variable data custom multi-media files over a network in accordance with various embodiments of the invention;

FIG. 16 comprises an illustration of an example data file that can be used to generate variable data custom multi-media files over a network in accordance with various embodiments of the invention;

FIG. 17 comprises an illustration of an example user interface displaying an imported data file as an array of output files in accordance with various embodiments of the invention;

FIG. 18 comprises an illustration of an example user interface for selecting layers of a video to assign to data files in accordance with various embodiments of the invention;

FIG. 19 comprises an illustration of an example user interface for selecting variable data custom multi-media files for processing in accordance with various embodiments of the invention;

FIG. 20 comprises an illustration of an example user interface displaying a preview of one variable data custom multi-media file generated in accordance with various embodiments of the invention;

FIG. 21 comprises a block diagram of an example operation of a user interface to generate variable data video in accordance with various embodiments of the invention;

FIG. 22 comprises a block diagram of an example process for processing variable data video in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

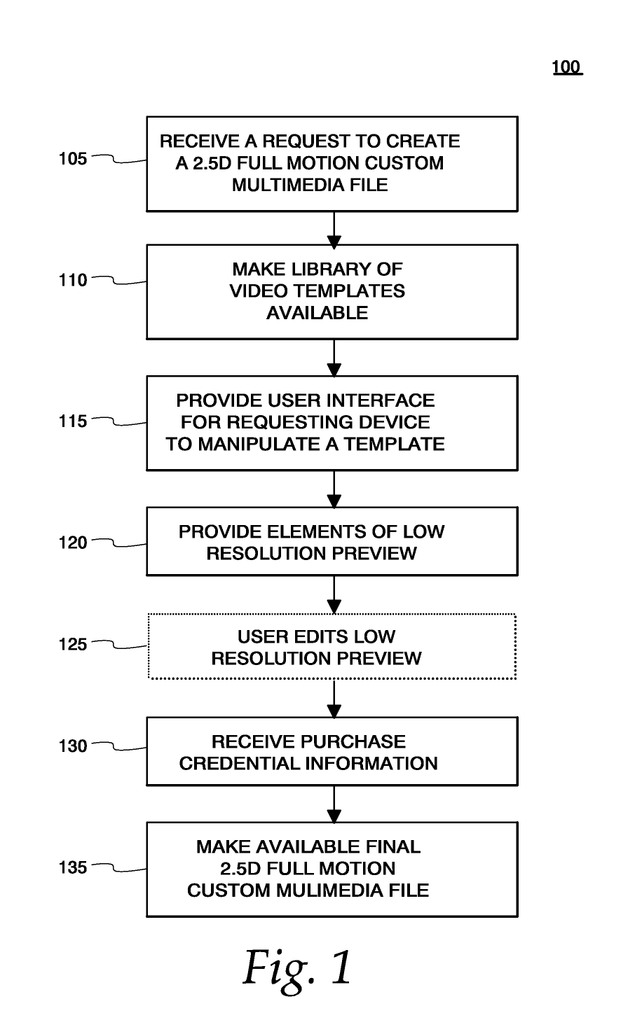

Referring now to the drawings and, in particular to FIG. 1, an illustrative process that is compatible with many of these teachings will now be presented. The method 100 of FIG. 1 includes receiving 105 by a computing device over a network a request from a requesting computing device to create a 2.5D full motion custom multi-media file. The computing device makes 110 a library of stored video templates available to the requesting computing device. In one example, the computing device provides signals to the requesting computing device to effect presentation of media available for purchase from third parties over an internet-based transaction. In other words, a user interface is provided, for example, through a web browser or through another computer based application, such that a user desiring to create a multi-media file can access a library of video templates to use in creating the user's custom file. The templates themselves are videos that can be manipulated using a user interface in a variety of ways to create a custom multi-media file.

For example, a library of stored videos can be accessed for a user to include within a given template. The video library may include videos aggregated from a variety of sources, including cloud-based storage libraries, videos created by the entity providing the capability to make a custom file, videos available by license, and other videos collected and processed to work within the system as described in further detail below.

One example for making 110 the library of stored video templates available includes receiving a media packet from a media providing computing device. In this approach, a media packet from a third party is downloaded from the separate media providing computing device controlled by a third party that owns or created the media. Once integrated into the current system, the media can then be made available to a user to serve as the basis of or be incorporated into a user's given custom multi-media file. After receiving the media packet from the media providing computing device, the media packet is processed with the computing device to determine errors in the media contained in the media packet. Additionally, the media packet can be processed by the computing device to extract metadata associated with the media packet and to extract assets other than the media from the media packet. Such assets can include any additional information related to the media, its use, or its content. The media metadata and assets are then stored in a storage device configured to make the media available to the requesting computing device in accord with the metadata. For instance, a particular media packet may come with certain use restrictions as may be defined in metadata associated with the media packet. The storage device can then store the metadata in association with the media such that use restrictions can be respected when making the media packet available to other users.

With respect to processing the media packet to determine errors within the media packet, the computing device may verify the media's file type and integrity. If there are problems with the media, the computing device can perform quality corrections to the media to create a corrected media file. The corrected media file can be transcoded to create a transcoded media file. Transcoding the media file standardizes the video for easier processing when creating to the full motion custom multi-media file for the user. In one approach, all video data is transcoded or converted to flash video and all still images are converted to JPEG or PNG type files. The computing device then returns the transcoded media file and data regarding the media's quality for storage. So configured, media from virtually any source can be incorporated into the system and made available to users in preparing custom video for their personal or business uses.

With reference again to FIG. 1, in response to receiving an indication of selection of a video template from the library of stored video templates, the computing device provides 115 a user interface for the requesting computing device to manipulate the template. The computing device also provides 120 elements of a low resolution preview of the 2.5D full motion custom multi-media file over the network for playback at the requesting computing device. The template is configured to allow the requesting computing device of a user to edit or manipulate 125 the elements of the low resolution preview of the 2.5D full motion custom multi-media file. Accordingly, the requesting computing device may periodically send during the editing process, and the computing device receives, signals to effect updating the low resolution preview. When the editing process is complete, the requesting computer sends, and the computing device receives, signals to effect creation of the full resolution 2.5D full motion custom multi-media file.

So configured, because the editing is done locally on the user's computing device, network bandwidth resources and the providing computing device's processing resources are conserved. The user also experiences reduced network transmissions related processing delays during the editing process. In one example, there is no network load during a user's editing text, placing elements, or changing filters during editing. In still another example, although adding new video images and/or audio to a file can increase network load, such files are generally the low resolution files that minimize this impact. Because the working version of the video is low resolution, and optionally watermarked, it is unlikely that a user will capture or otherwise use the low resolution version of the multi-media file, thereby largely ensuring that the user will proceed with payment to the service provider when an acceptable final product is produced.

The editing of the templates will vary depending upon what the user wants in the final video and what the capabilities and design of the given template are. For example, one given template may include a variety of video that includes animations and movement, which have embedded therein blank spaces into which a user may enter text, images, or additional video. The template itself is built from a markup language for describing the composition and movement of video elements in a 2.5D space. The video elements may include external audio, image, and video elements or internal text and simple shape elements. External elements are fetched as separate files and may be provided by the computing device executing the method or from third party devices. Internal elements are directly rendered from data in the given template using method to search, preview, add via user upload, and license external content.

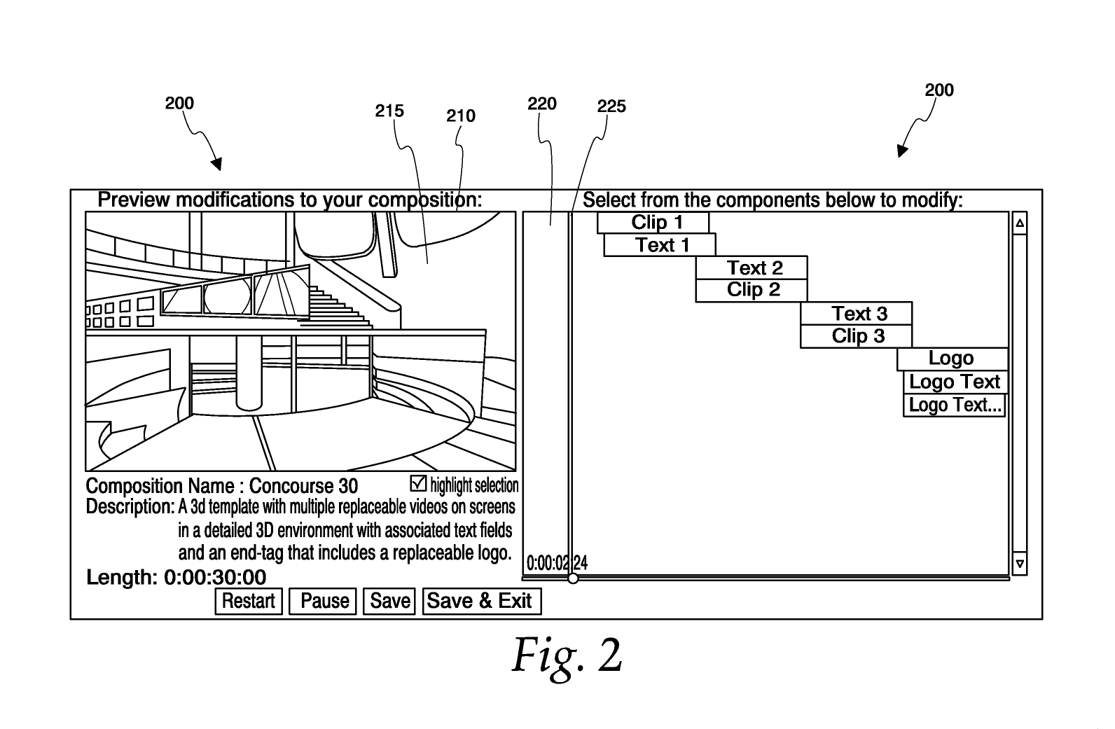

FIGS. 2, 3, and 4 illustrate an example user interface 200 that can be provided to a user from the computing device to allow the user to edit a video template. The user interface 200 includes a preview window 210 that displays the template being edited by the user. In this example, the template includes a motion video 215 depicted within the window 210. A second window 220 illustrates a timeline for the displayed template and elements (illustrated here as boxes) representing the user modifiable portions of the template. A time indicator line 225 shows where the template displayed in the preview window 210 is on its playback timeline. The boxes are oriented within the window 220 according to the time during the template at which the respective user editable portion is visible. The user interface 200 can also include additional information such as the template-based working video's name, a short description of the working video, the length of the working video, and various buttons to control the playback and to control saving the working video.

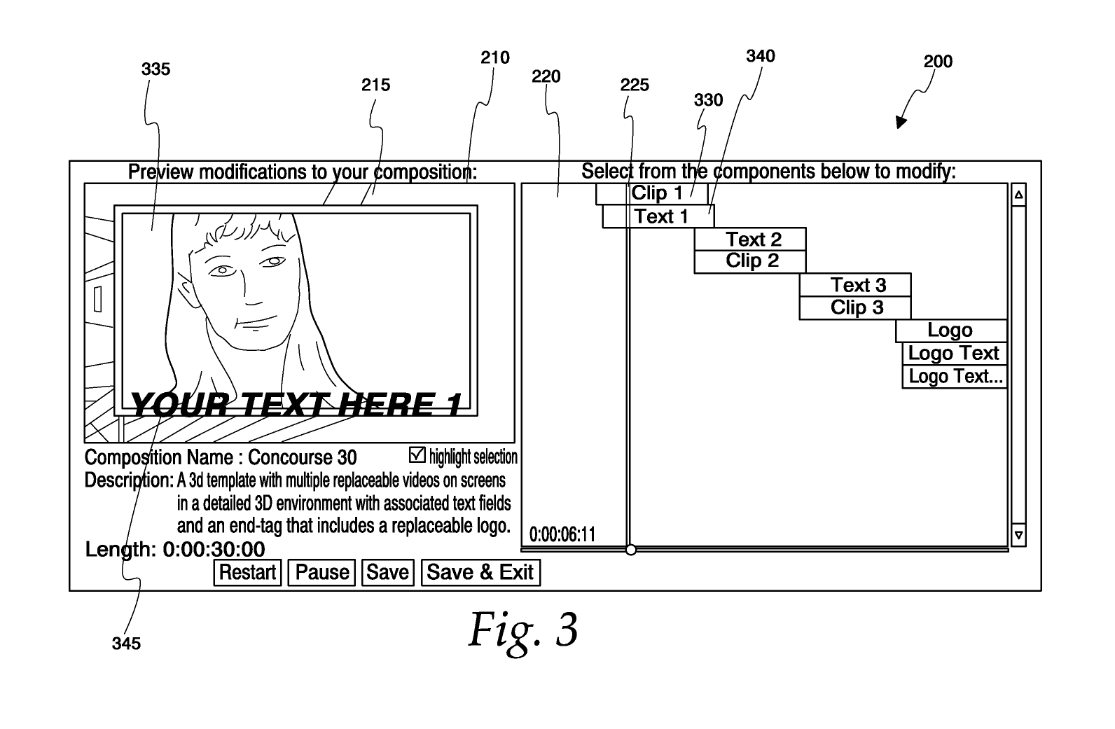

As the working video or template advances in time, and with reference to FIG. 3, the time indicator 225 overlaps with an element labeled “clip 1” 330, which illustrates where a video clip can be inserted into the template played in the window 210. The illustrated example template at this point in time includes the video template imagery 215 illustrated in the background of the window 210 and a portion of the video 335 that displays the clip as selected by the user. Further, element 340 is labeled “text 1” to illustrate a portion of the template that is user editable at this portion of the video template. The text is displayed in the window 210 at the illustrated portion 345 of the video.

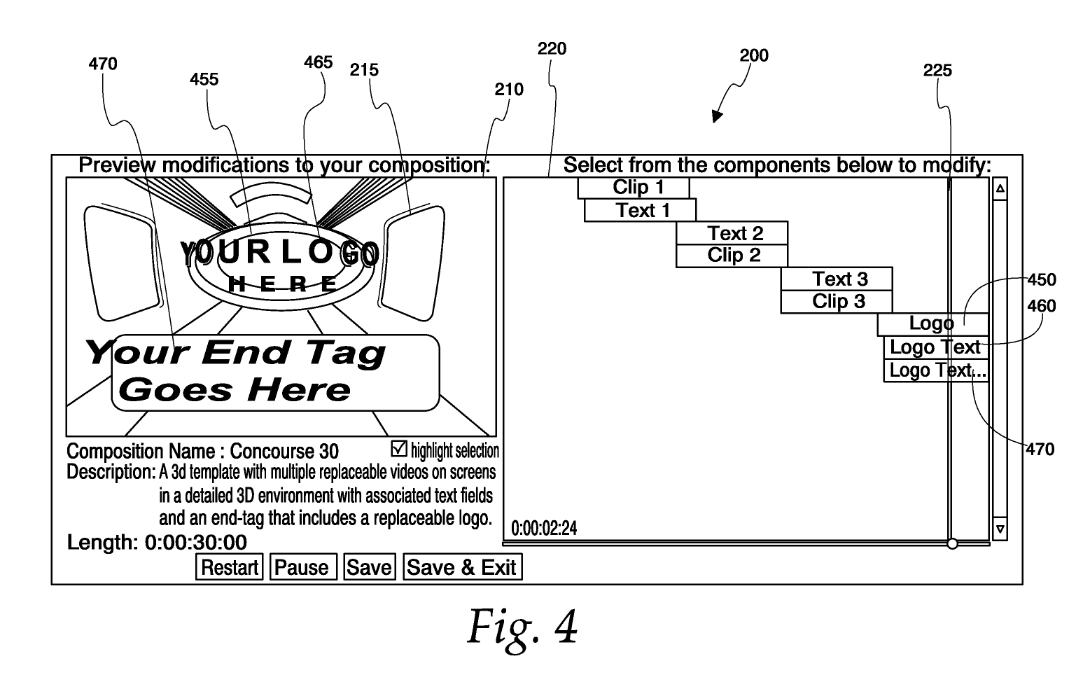

FIG. 4 illustrates yet another example of the template editing interface illustrated in FIGS. 2 and 3, now at the time indicated by the time bar 225 towards the end of the template. In this example, the element 450 indicates that a logo can be inputted and displayed at the portion 455 of the template illustrated in window 210. The logo would overlap the other video playing in the background portion 215. Element 460 illustrates that logo text can be added at the portion overlapping the logo indicated at video portion 465. An element 470 indicates that further text can be added at another portion 470 of the template. FIGS. 2-4 illustrate merely one example of a user interface that can be provided to enable editing of the template by the user's computing device. Through such a user interface, the computing device can receive video data, receive text, receive audio data, and receive picture data from the requesting computing device for incorporation into the 2.5D full motion custom multi-media file. The computing device may also receive signals to change a length of the 2.5D full motion custom multi-media file.

In some examples, elements that appear in the timeline constitute “layers” that can be used in connection with variable data video (also referred to as variable data custom multi-media files). As used throughout this application, the term “layers” refers to elements on a timeline that represent and/or are associated with output that is to be displayed from a custom multi-media file at and/or during a certain period of time of the playback of custom multi-media file. For example, in reference to the embodiments described above, elements 330, 340, 450, 460, and 470 can be considered layers. The output associated with the layers can include graphical output, video output, audio output, and/or combinations thereof. For example, the output can include video files, image files, text files, audio files, flash animation files, and the like that are displayed in a custom multi-media file generated as described herein. The output can thus be used to display images/videos of employees, products, or locations. The output can also be used to display company logos, addresses, slogans, names, directions, or the like. The output can also be used to generate/display sounds such as jingles, slogans, or the like (the term “display” as used herein encompasses the generation of audible sounds). The output associated with these layers will appear during the time of the custom multi-media file in accordance with the layers' representation on the playback timeline.

The computing device can make available to the user the option to choose pre-stored media for incorporation into the user's video instead of, or in addition to, having the user upload media to incorporate into the video. For example, the computing device can make available to the requesting computing device a library of stored audio files or templates. In response to receiving an indication of selection of the template from the library of stored templates that includes audio, the computing device can provide for the user interface to allow the requesting computing device to send signals effecting editing of the video template to add or modify audio as part of creating the 2.5D full motion custom multi-media file. Similarly, the computing device can receive from the requesting computing device a text based message to be added as audio to the 2.5D full motion custom multi-media file. In response to receiving the text based message, the computing device can send an order to effect receipt of an audio track based on the text based message and make the audio track based on the text based message available to the requesting computing device for incorporation as part of creating the 2.5D full motion custom multi-media file per instructions received through the user interface. In this approach, the computing device can automatically place an order with a third party vendor whose business it is to provide audio voiceovers based on submitted text. The computing device will then receive from a vendor computing device an audio file corresponding to the voiceover of the text based message, which audio file can then be provided to the user via the user interface device for incorporation into the custom multi-media file. In another approach, text can be automatically converted to an audio track using known methods.

Returning again to FIG. 1, the computing device provides 120 elements of a low resolution preview of the 2.5D full motion custom multi-media file over the network for playback at the requesting computing device. The low resolution preview may be the initial template to be edited by the user or intermediate versions updated during the editing process. To be able to provide to low resolution preview according to one approach, the computing device processes the media packets from a media providing computing device when making the library of stored video templates to create a low resolution media version for use in providing a low resolution preview. Accordingly, the low resolution media version can be provided in the preview window of the user interface device. In another example, when a modified 2.5D full motion custom multi-media file is prepared and a preview is requested, the computing device analyzes the 2.5D full motion custom multi-media file to build a list of required preview elements. The computing device also determines capture methods for the elements of the 2.5D full motion custom multi-media file and transcodes elements of the 2.5D full motion custom multi-media file to create transcoded elements to use in the low resolution preview. The computing device then builds the low resolution preview of the 2.5D full motion custom multi-media file using the transcoded elements. When editing is complete, the requesting computing device will so notify the computing device, which receives 130 information relating to purchase credentials relating to the 2.5D full motion custom multi-media file. The purchase credentials can be any of a variety of forms that allow the user to pay the operator of the computing device for the service of providing the ability to create a custom 2.5D multi-media file and, optionally, to account for licensing fees incurred in connection with any of the elements used as part of the custom 2.5D multi-media file. For example, a user may pay a one-time fee for creating the single 2.5D multi-media file, or the user can buy one or more subscriptions that allow defined access to the computing device to make an unlimited or pre-defined number of 2.5D custom multi-media files. Moreover, various subscriptions can be defined that provide access to difference libraries of content that can be used in creating a given 2.5D multi-media file. In response to receiving the information relating to purchase credentials, the computing device makes available 135 the 2.5D full motion custom multi-media file to the requesting computer device. The final 2.5D multi-media file can be provided to the user in any of a variety of fashions known to those skilled in the art.

By one approach, to finalize the file prior to provision to the user, the computing device gathers elements of the 2.5D full motion custom multi-media file and renders individual frames of the 2.5D full motion custom multi-media file. The elements gathered include the audio, video, picture, text, and/or other media incorporated into the final video. The individual frames are built up of the various individual aspects of a given video as will correspond to a given frame of the video. Thus, text, video, still pictures, portions belonging to an original template, and the like that are all part of a particular image of the 2.5D full motion custom multi-media file will be compiled together into a single individual frame saved using a particular format such as a PNG format. The computing device saves the individual frames as an image sequence and encodes the image sequence together into the 2.5D full motion custom multi-media file.

Where the 2.5D full motion custom multi-media file is compiled from a data feed, the computing device processes the data feed identifying elements to compile into the 2.5D full motion custom multi-media file by compiling a data compilation identifying elements available for use. The computing device gathers elements identified in the data compilation that are needed to compile the 2.5D full motion custom multi-media file and builds a rendering packet that identifies the elements for rendering when compiling the 2.5D full motion custom multi-media file. So configured, the computing device has a list of all components that are needed to create the individual frames that are then later rendered into a video image.

In one approach, the functionality or logic described above may be embodied in a form of code that may be executed in a separate processor circuit of the computing device. If embodied in software, each block may represent a module, segment, or portion of code that comprises program instructions to implement the specified logical function(s). The program instructions may be embodied in the form of source code that comprises human readable statements written in a programming language or machine code that comprises numerical instructions recognizable by suitable execution systems such as a processor in a computer system or other system. The machine code may be converted from the source code, etc. If embodied in hardware, each block may represent a circuit or a number of interconnected circuits to implement this specified logical function. In one such example, a non-transitory computer readable medium can store instructions that cause a computing device in response to reading the instructions to perform the operations described above.

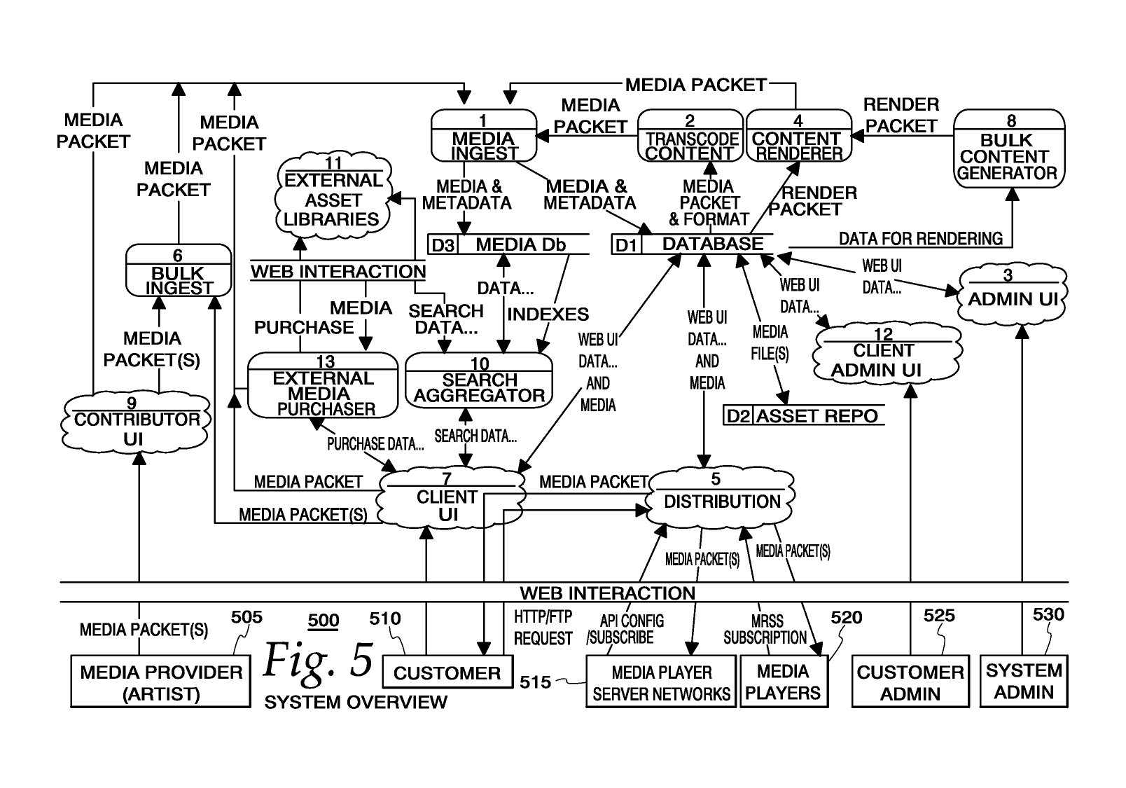

Those skilled in the art will appreciate that the above described processes are readily enabled using a wide variety of available and/or readily configured platforms including partially or wholly programmable platforms as are known in the art or dedicated purpose platforms as may be desired for some applications. Referring now to FIG. 5, an illustrative approach to such a platform will now be provided. FIG. 5 illustrates the system overview whereby a computing system 500 is configured to execute the functions described above and is configured to have interaction over a network such as the internet with a variety of other devices controlled by other entities such as a media provider device 505, a customer device 510, a media player server network device 515, a media player device 520, a customer administrator device 525, and a system administrator device 530.

In FIGS. 5-13, each illustrated process may be performed by separate computing devices operating under the control of a single entity or by a single computing device. It will be understood that the processes described above could be executed by a single computing device or that a “computing device” may include multiple computing devices. The symbols of FIGS. 5-13 illustrate specific aspects of the illustrated example. For instance, each box with rounded corners represents a process executed by the computing device. Databases are illustrated as boxes adjacent a separate rectangle and marked with the moniker “D” with a number. These databases may be physically separate databases or simply different logical storage areas in a single database. Cloud symbols indicate interconnection processes whereby the computing system 500 communicates with other systems to effect the processes described above. A box with sharp corners represents a separate system or computing device in communication with the system 500. Data flow among the various elements is indicated by the arrows with an indication of the type of data being exchanged being provided by text associated within individual arrows.

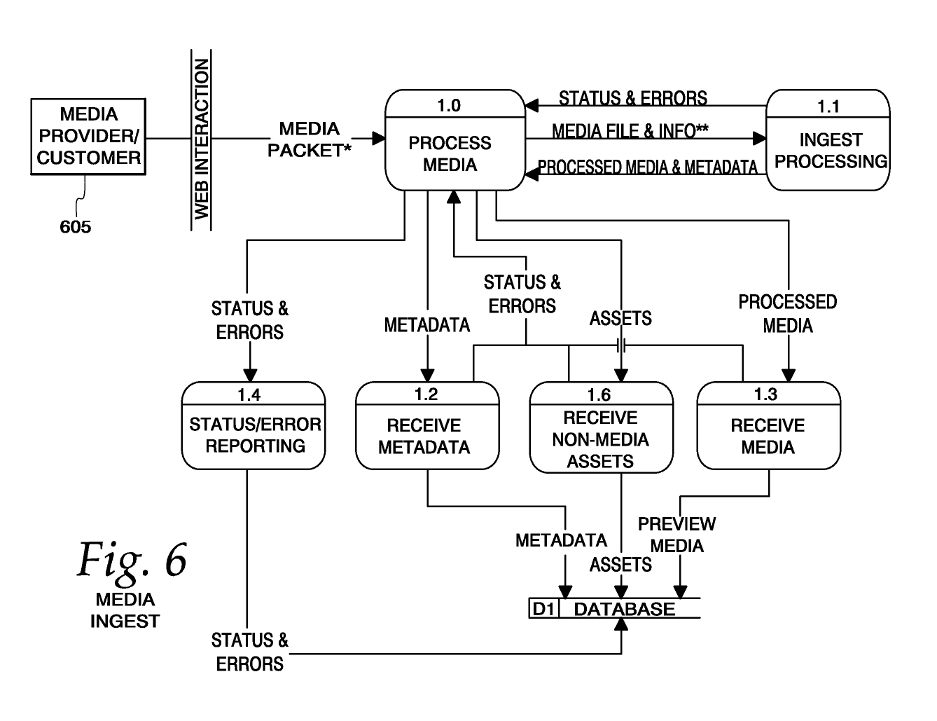

The system 500 of FIG. 5 includes a media ingest process 1 that accepts media files from customers and providers and processes the files for use within the system 500. Turning to FIG. 6, an example of a media ingest process 1 is illustrated. In this example, a media packet is received from a media provider or customer computing device 605 by the process media element 1.0. The media packet may include a media file, entitlement information, licensing information, and arbitrary metadata supplied by the provider of the media packet. The media file and information is provided to an ingest processing element 1.1, which returns the processed media and metadata to the process media element 1.0. The media ingest process 1 further includes a received metadata process 1.2 that receives the metadata from the process media process 1.0 and prepares the metadata for storage in the database D1. A received media process 1.3 receives the processed media from the process media process 1.0 and configures it for storage in the database D1. By one approach, the received media processed 1.3 can include a routine to provide only preview media for the database for use in the process of creating a 2.5D full motion custom multi-media file.

A receive non-media assets process 1.6 is configured to receive assets from the process media process 1.0 including full resolution media from the process media process 1.0. The various processes illustrated in FIG. 6 may also determine status messages and error messages during their normal routines. These messages are sent to the process media process 1.0, which in turn provides this information to a separate status/error reporting process 1.4. The status/error reporting process 1.4 processes the status and errors whereby such information regarding errors or status information may be provided and stored in the database D1.

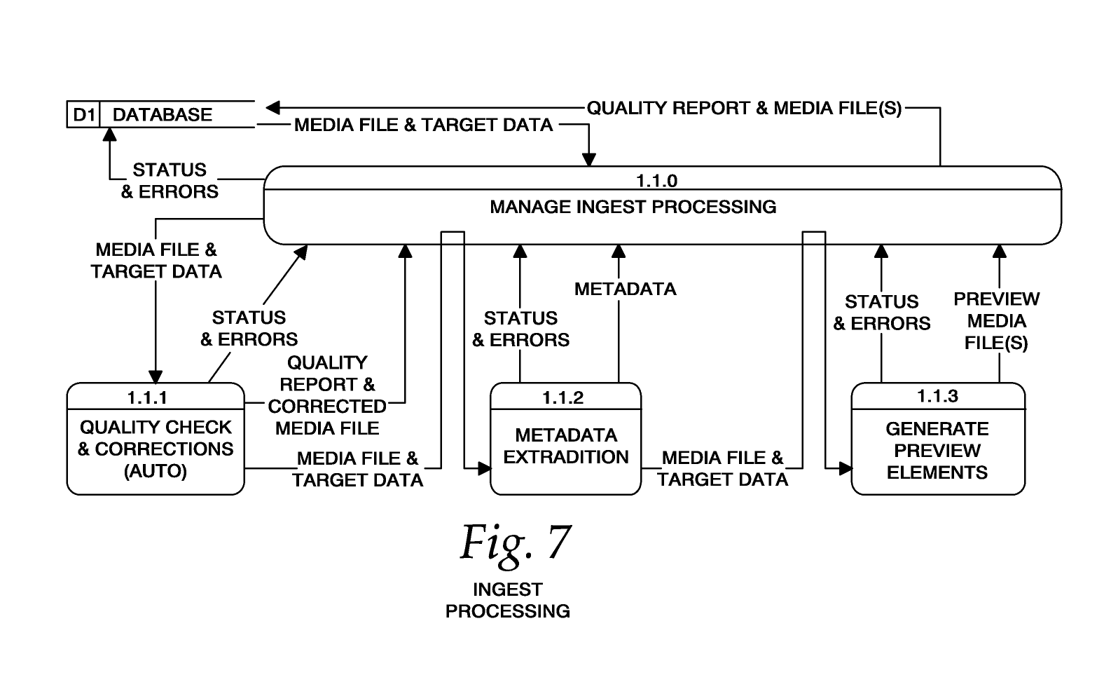

Turning to FIG. 7, the example ingest process 1.1 of FIG. 6 will be further described. The ingest processing process 1.1 functions to pull apart the provided media files to extract information and create low resolution versions of the media for reference within the video editor. A manage process 1.1.0 receives the initial media file and target information or data from a database D1 or through the media ingest process 1. Its process manager 1.1.0 coordinates the processing of the data. The media file and target data are first sent to a quality check and corrections process 1.1.1. The quality check and correction process 1.1.1 checks for file integrity and usability including compatibility with a processing format for the system 500 and final form of the 2.5D custom multi-media file. If corrections to the data can be made, the quality check and corrections process 1.1.1 makes those corrections including transcoding the content as appropriate.

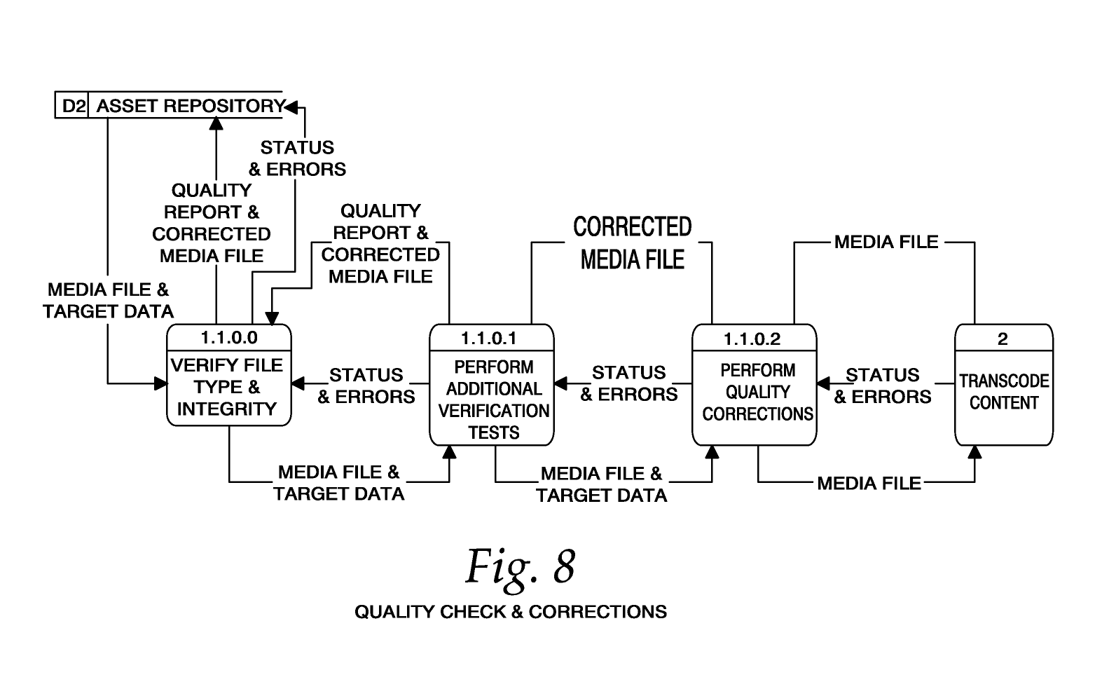

FIG. 8 illustrates an example of quality check and corrections process 1.1.1 including a verify file type and integrity process 1.1.0.0. As the name implies, this process receives the media file and target information and verifies whether the file type and integrity of the file are sufficient for use in a custom multi-media file. Depending on the results of this process, additional verification tests may be performed in a further process at 1.1.0.1. If the additional tests confirm that quality corrections need to be made to the media, the media and target data are sent to a perform quality corrections process 1.1.0.2 that is configured to correct the media. If the quality correction includes a need to transcode the media from one media type to another, the media file is provided to a transcode content process 2 that returns the transcoded media file to the perform quality corrections process 1.1.0.2. The corrected media file is then returned to the perform additional verification tests process 1.1.0.1, which then provides a quality report and the corrected media file to the original verify file type and integrity process 1.1.0.0. The quality report and corrected media file are then provided to an asset repository database D2 for use by other processes within the system. This quality report and corrected media file are also returned to the manage ingest processing process 1.1.0, as illustrated in FIG. 7. This process also includes a metadata extraction process 1.1.2 that extracts the metadata from the media file and target data for processing into a form that the remainder of the system 500 can access and use. Lastly, the ingest processing process of FIG. 7 includes a generate preview elements process 1.1.3 that generates a preview version of the media for use in the preview mode.

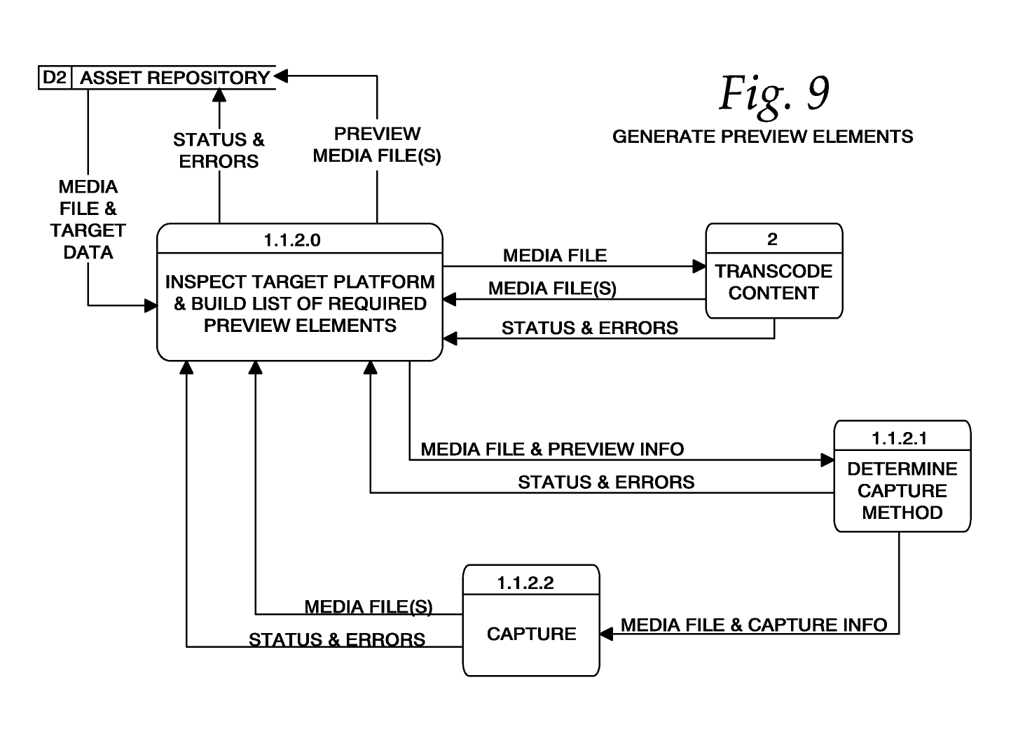

FIG. 9 illustrates an example generate preview elements process 1.1.3 that builds a platform specific appropriate preview media asset that accurately represents the high resolution master copy of the media. In this example, the target platform is inspected and a list of required preview elements is built based upon the media file and target data received from the database or from an earlier process manage ingest process. This analysis is controlled by an inspect target platform and build list of required preview elements process 1.1.2.0. If the received media file does not have a form appropriate for the target platform, the media file is provided to a transcode content process 2 that returns transcoded media files having a file type appropriate for the target platform. As part of the preview element creation process, it may be necessary to determine the capture method using process 1.1.2.1, which capture information is used by a capture process 1.1.2.2 that will recapture the image or video in a manner that creates a low resolution media file suitable for use as part of an overall preview of the custom multi-media file. The inspect and build process 1.1.2.0 then returns the preview media files to the asset repository database D2 along with a report of any status and errors created by any of the other processes involved in creating the preview media files. In the context of the media ingest process illustrated in FIG. 7, the generate preview elements process 1.1.3 may also return the preview media files to the manage ingest process 1.1.0 for processing or reporting the process information before storage of the media files in the database.

Turning again to FIG. 5, the media ingest process 1.1 receives media for processing from a variety of sources including media from a media provider or artist computing device 505 via a contributor user interface 9 and a bulk ingest process 6 configured to receive media packets from the contributor user interface 9 and a client user interface 7. Through these user interfaces, the bulk ingest processor process 6 can receive media from a customer computing device 510, or a media provider computing device 505. The bulk ingest process 6 is configured to process large amounts of media as provided by these entities in such a way to allow the media ingest process 1 to handle the information. The media ingest process 1 can instead receive the media packet directly from the client user interface 7 if the media packet provided is not so large as to need to be processed by the bulk ingest process 6.

The transcode content process 2 is illustrated as receiving media from the database D1 and providing media packets to the media ingest process 1. The database in this example is used as a go-between various users of the overall system 500 and processes executed by the system 500 in order to create a custom multi-media file. For example, the database D1 can receive data from the client user interface 7, the administrator user interface 12, or from a system 500 administrator user interface 300 to effect communications or receive information from the consumer computing device 510, the customer administrator computing device 525, or a system administrator computing device 530. Depending on how the data is needed in the other processes, the database D1 can then be accessed by a variety of processes within the system 500. Another example of such a process is the content renderer process 4.

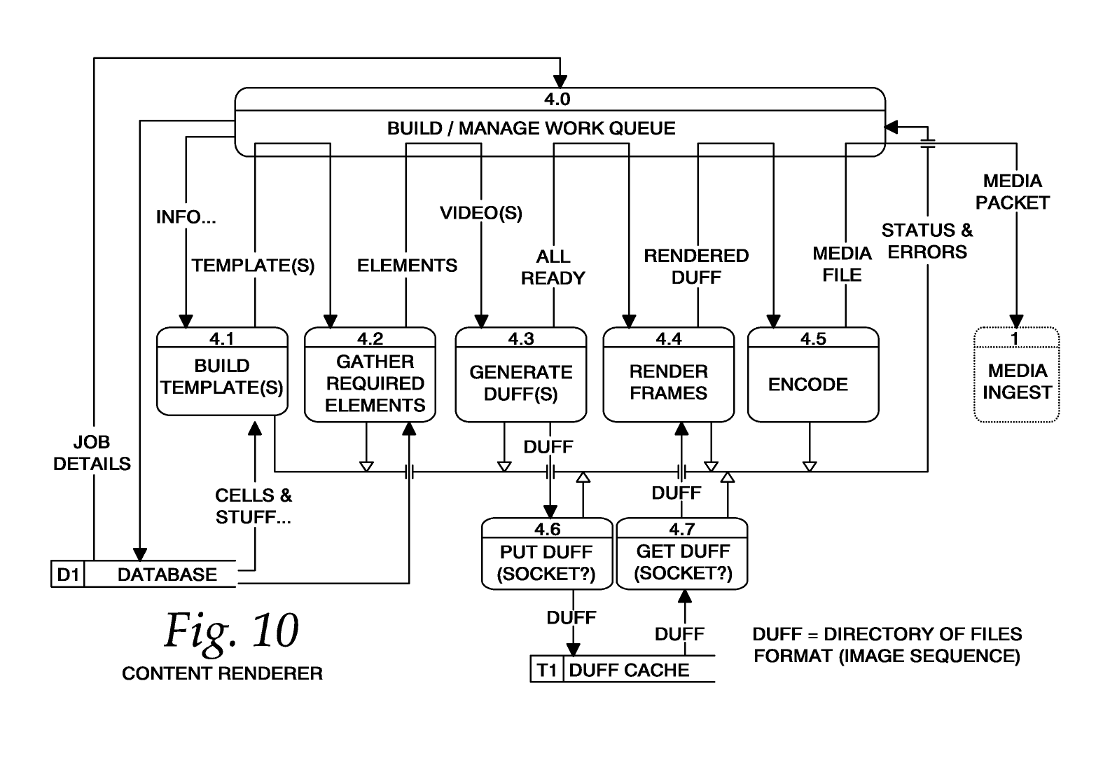

FIG. 10 illustrates an example content renderer process configured to pull together all of the high resolution assets used in a user's composition or custom multi-media file, and builds a presentation based on that composition. Generally speaking, the presentation is played frame by frame and then captured on a frame by frame basis to create an image sequence ready for encoding into a distribution platform specific file format. A build/manage work queue process 4.0 manages the overall process. A build templates process 4.1 receives information regarding the overall work process from the work queue 4.0 and cells of the custom multi-media file from the database D1. The generated templates are then provided to a gather required elements process 4.2 that collects together all the elements for a specific frame that are collected together to create the individual frame that will later be used in the full video. The list of required elements is provided together with the video to a file format generation process 4.3 that creates a directory of files format (DUFF) that builds a table of files needed for each image of the image sequence. The DUFF information can be provided to a put DUFF process 4.6 that stores the information in a separate cache or memory T1 for later retrieval by a get DUFF process 4.7. A render frames process 4.4 renders the individual frames of a custom file and, in so doing, calls the DUFF information via the get DUFF process 4.7. The render frames process 4.4 uses the DUFF information to collect the individual media elements of the various parts of the individual frame of the video to allow the process to create the final individual frame. An encode process 4.5 encodes the individual frames together into a single video media file that represents the custom 2.5D multi-media file to be delivered to a user. This media file can be provided to the media ingest process 1 for processing to ensure safe storage and indexing of the information. Status information and error information for any of the above processes are collected and provided to the build/manage work queue process 4.0 to facilitate management of the overall process.

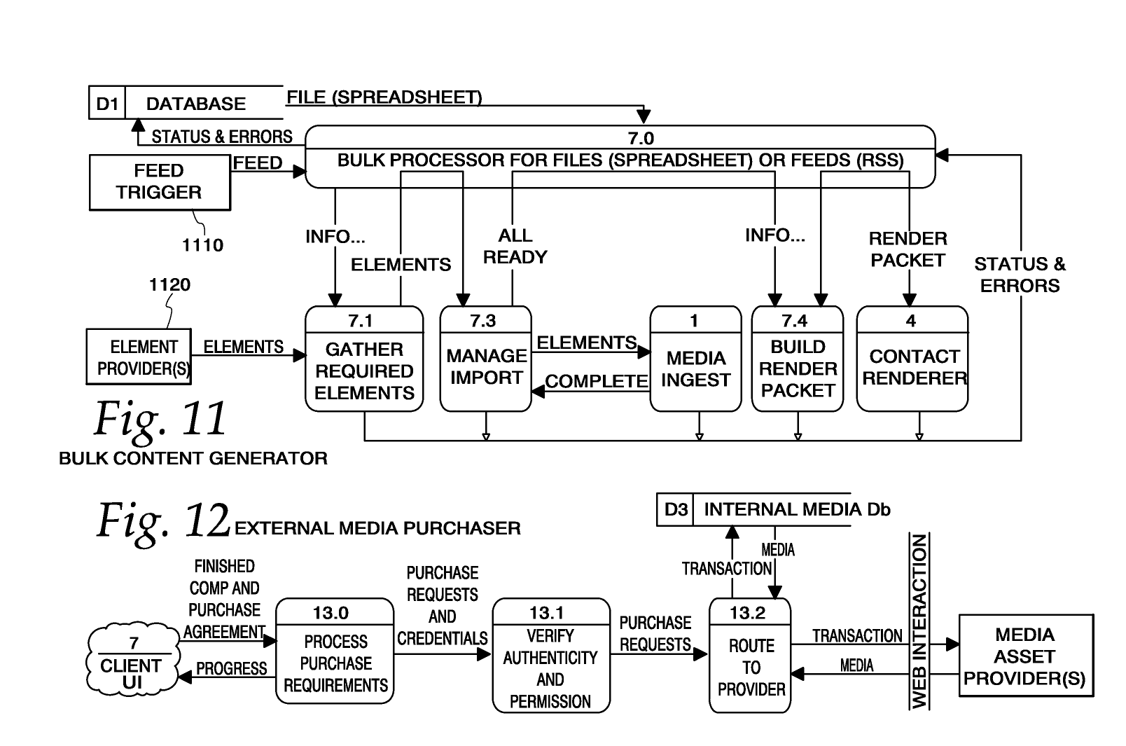

In a situation where bulk amounts of content need to be rendered, a bulk content generator process 8, as illustrated in FIG. 5, can pull data for rendering from the database D1 and prepare rendered packets individually to the content renderer process 4. An example bulk content generator process as illustrated in FIG. 11 processes the data feed by pulling out data to be injected into the user's composition or custom multi-media file. The composition is then copied and edited for each version of the file and handed off the rendering for final production. This process is managed by a bulk processor 7.0 designed to handle files such as spreadsheet files or feeds such as RSS feeds. A feed trigger, such as a file or RSS feed is received from the bulk processor 7.0 from a separate feed trigger device 1110. The RSS feed or file can then be incorporated into a template or video. A gather required elements process 7.1 receives information regarding the media to process from the bulk processor 7.0 and from an elements provider device 1120, which in this example is a responsive server for this process. The gathered elements are provided to a manage import process 7.3 that is designed to work with the media ingest process 1 to collect together the elements on a one by one basis until the file is fully compiled. This information is provided to a build render packet process 7.4 which information is provided to the content render 4 to facilitate the final rendering of the content as described above.

Turning back again to FIG. 5, media to be used in creating a custom multi-media file can be received not only through specific media contributors and customers, but also through other external sources. In the example of FIG. 5, a client through the client user interface 7 can interact with an external media purchase process 13 that facilitates the client's purchase of media through external asset libraries 11. When purchased, these external media assets are then provided to the media ingest process 1 as described above.

An example external media purchaser process is illustrated in FIG. 12. Generally speaking, the example process accepts purchase requests from users through a client interface. The process routes and manages the transactions with external or third party media provider partners and through internal accounting systems to facilitate purchase of the media and delivery of the media to the media ingest process in accord with target requirements. The client, through the client user interface 7, browses media purchase options and sends information regarding a final composition and purchase agreement that is received by the process purchase requirements process 13.0. The process purchase requirements process 13.0 forwards the purchase request and credentials information to a verify authenticity permission process 13.1 that acts as a screen for such purchasing requests. If the purchase requests are approved, they are provided to a route to provider process 13.2 that accesses an internal media database D3 to collect information with respect to which third party asset provider is providing the content being purchased and the rules for engagement with such third party. The route to provider process 13.2 then initiates and completes the transaction with the media asset provider or other third party media provider or artist. The database D3 may include a listing of third party media providers, the type of media that they provide, pricing structures for such media, and content information for such third party asset providers. Such information may be kept within the system 500 or as an external media asset library 11. When the transaction with the third party media asset provider is complete, the media is provided back to the system 500 via the route to provider process 13.2. The media is then, as illustrated in FIG. 5, provided to the media ingest process 1 to be processed as described above.

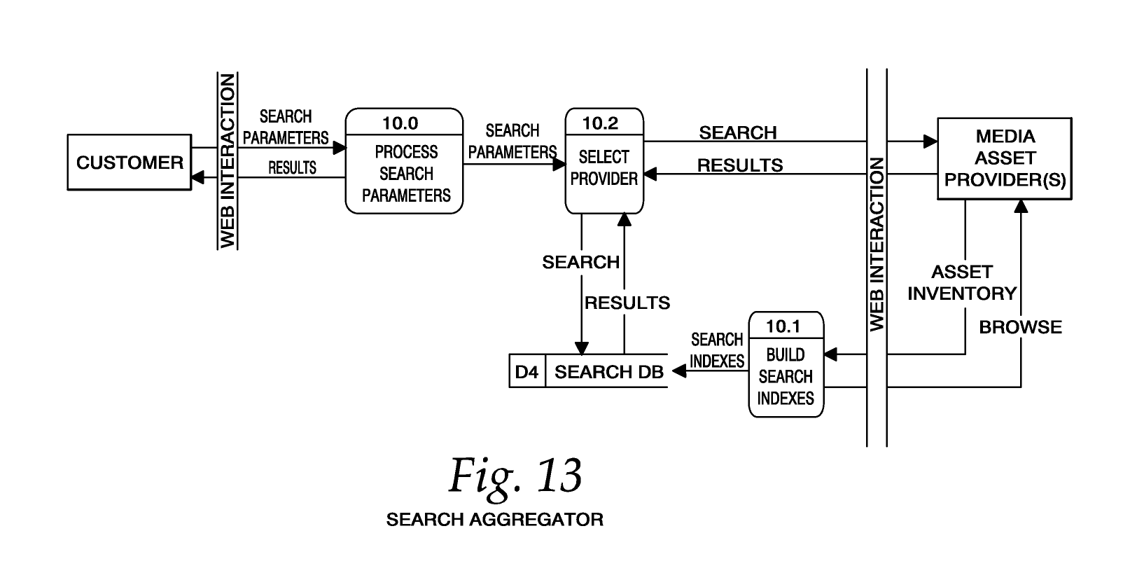

With all of the various media available to a user to build up a 2.5D custom multi-media file, various information processing and organization systems can be used to facilitate ease of use. For example, in FIG. 5 a search aggregator process 10 is available to a user through the client user interface 7 and uses indices provided by system databases such as database D3 to facilitate searching for and use of various stored media. FIG. 13 illustrates an example search aggregator process that accepts the user's media search parameter and gathers search results from the system 500′s media library and from media provider partners having media libraries having third party libraries available for use. The search aggregator process normalizes the third party media library information for search and information provision. In response to a final selection by a user, the search aggregator process accepts a purchase identification and can handle a transaction with an external media provider. In the illustrated example, a process search parameters process 10.0 receives search parameters from the customer and returns the results to the customer device. The search parameters are provided to a select provider process 10.2 that determines which provider will be searched in response to the search request. The search provider process 10.2 can access an internal database D4 that includes search indices for both internal databases of information and information from third party media asset providers. To facilitate creation of such a database D4, a build search indices process 10.1 receives asset inventory information from third party media asset providers and processes the information to match the search indices format for the search database D4. The build search indices process 10.1 can also occasionally browse one or more media asset provider libraries to update the search database D4 as needed. Alternatively, the select provider process 10.2 can directly access the media asset provider information in response to receiving information from the search database D4 with respect to available information at a third party media asset provider.

The final 2.5D full resolution custom multi-media file can be made available to a user from the system database D1 in a variety of ways. As illustrated in FIG. 5, a distribution process 5 can receive the media and provide the media to various devices over a network interaction. For example, the media can be provided in response to receiving API (application programming interface) Config/Subscribe information from media player server networks device(s) 515. In another example, the media can be provided in response to receiving MRSS (multimedia rich site summary) subscription information from media players 520. In other words, the media file can be provided directly to video services such as YouTube or the like as requested by the user. The media can also be provided through a client user interface to the customer 510, for example, in response to HTTP/FTP requests.

So configured, a user can access a system to choose a template to edit using stock or original video, text, audio, or still images to readily create a custom 2.5D multi-media file as a fraction of the cost of producing such a video from scratch. The video can be previewed using a low resolution to facilitate fast review of the work, and a variety of pricing and licensing structures are made available to facilitate incorporation of plethora aspects into the file. The final file is then ready for download to a user for use in website advertising or the like.

The present disclosure also provides embodiments of a method for generating variable data custom multi-media files (or variable data videos), and computer systems and apparatuses for implementing such methods. Variable data custom multi-media files can be a series of videos that are similar to one another in some aspects, but that present different information, or display different outputs, in certain locations and/or time intervals. In this manner, a series of variable data videos may present the same graphics and/or sound as a base portion (e.g., a primary or background portion) of each video, with different graphics and/or sound in an overlay portion (e.g., textual and/or graphical outputs, etc.) of the video. For example, a series of variable data videos may all present the same background video footage with different textual overlays (e.g., corporate names, corporate addresses, particular sales or offers, etc.) that provide unique information that is intended for display to different audiences.

In some examples, variable data videos can present a series of advertising videos for each of a number of individual units of a franchise. For example, an automobile distributor may generate variable data advertisement videos for each of a number of automobile dealerships in a given region. The base portion of each video may be the same or generally the same. For example, the base portion may show various videos and images of an automobile (e.g., the automobile interior and/or exterior, the automobile driving, etc.) and information pertaining to the automobile (e.g., the year, make, and model of the automobile, the gas mileage of the automobile, etc.).

The overlay portion, on the other hand, may differ from video to video to provide unique information pertaining to each of the particular dealerships. For example, during a particular portion of each variable data video, a graphic may appear that displays the name and address of the particular dealership. In this manner, the variable data videos can be similar—they can even be essentially the same—but with particularly crafted information that is unique for each dealership.

The presently described methods and computer systems provide techniques to quickly and efficiently make a series of variable data videos that share a common base video but that still provide variable data that is unique for each video.

In some examples, methods for generating variable data video can involve generating variable data custom multi-media files (e.g., videos) based on information maintained in a data file. For example, data file can include a spreadsheet, database, or other file of variable data. The data file can include an array (or a table, matrix, etc.) of output files, whereby the output files represent the variable data. In some aspects, the rows of the array will correspond to the independent variable data videos. That is, where a project intends to generate 25 variable data videos, there may be 25 different rows in the spreadsheet, with each row representing an independent variable data video. The output files in each spreadsheet row can be assigned to be displayed as an output over the base portion of the generated video.

Each row of the array can include one or more fields (e.g., columns of a spreadsheet) that each comprise output files. The output files can include graphical files (e.g., text files, image files, video files, etc.) audio files (e.g., sound clips), or combinations thereof. For example, the output files can simply be text in a spreadsheet cell, whereby that text will be generated as an output in the individual variable data video. In some examples, the output files can include image, video, or audio files. In some examples, the output files can include links or references to other files, which other files can contain text files, video files, image files, audio files, or the like.

Via an interface (e.g., the user interfaces and other programs described herein with respect to this or other embodiments), a user can import/upload data files from a computing device. For example, a user can save a spreadsheet file (e.g., as a .csv file or other file) with an array of output files on a requesting computer and then request, via the user interface, that spreadsheet file to be uploaded or imported to another computing device through a network. The user can then select a video template (e.g., according to one or more of the methods described herein with respect to this or other embodiments) for generating a custom multi-media file. Via the user interface the user can assign one or more rows and/or columns of the spreadsheet to an individual video that is associated with the template. When generating variable data videos, the output files of that spreadsheet row will be assigned to the variable data outputs of the associated individual variable data video. In some examples, the data file will include a plurality of rows, with each row being assigned to a separate independent variable data video.

The template may include a series of elements, or layers, that represent display of an output over a particular time period of the video. The output for these layers can be controlled via the user interface so that the output can be manipulated by the user, as described herein with respect to this or other embodiments. In certain examples where variable data videos are to be generated, a user can associate fields of output files (e.g., columns of the spreadsheet) to the layers of the video template. In this manner, each of the variable data videos may generate a different output depending on the output file in the associated field for each row/video of the data file. For example, the user can assign a first column of output files to a first layer that is associated with an output that overlays the video during a first time period, and assign a second column of output files to a second layer that is associated with an output that overlays the video during a second time period. So configured, the computing device can generate variable data videos such that the output files in the first column of each row of the data file dictate the output displayed during the first time period of the video, and the output files in the second column will dictate the output displayed during the second time period of the video.

Based on this assignment, the computer can generate and/or render custom multi-media files with variable data based (at least in part) on the output files in the data file. Each of the output files can be displayed as a separate output, or the output files can be used to control or effect the display of an output associated with the various layers of the video template. In some examples, the layers can be added, removed, modified, or otherwise controlled by the user via the user interface as described herein.

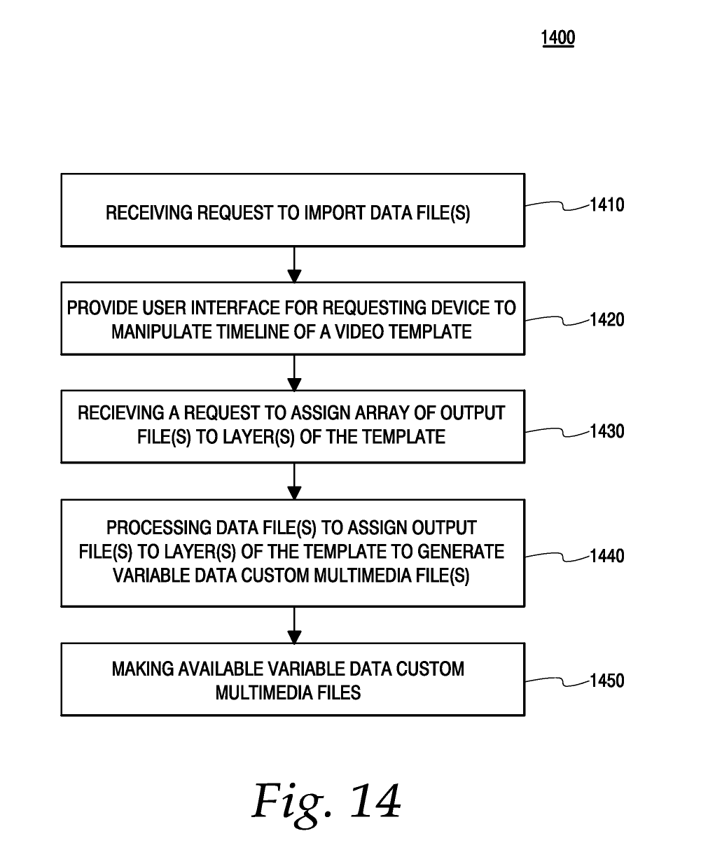

Examples of methods for generating variable data videos are demonstrated in the flow diagrams and exemplary screen shots of FIGS. 14-22. FIG. 14 shows a flow diagram of one exemplary method 1400 of providing the ability to generate variable data custom multi-media files over a network. In some instances, the method 1400 of generating variable data video is used in connection with the methods of creating network based video described herein. In other examples, the method 1400 can start with a custom multi-media file generated by the methods provided herein or by other methods.

The method 1400 includes receiving 1410 by a computing device over a network a request to import data files from a requiting computing device. The receiving 1410 can result from a user operating a user interface on a computer (e.g., a requesting computer) to request to import, or upload, a data file. For instance, a user may request to import a data file by clicking on or otherwise selecting an import or upload feature on the user interface, and then selecting the data file to import. In some examples, the data file can be a file saved locally on the requesting computer. In other embodiments, the data file can be saved remotely, for example, on a cloud or on another computer accessible remotely over a network.

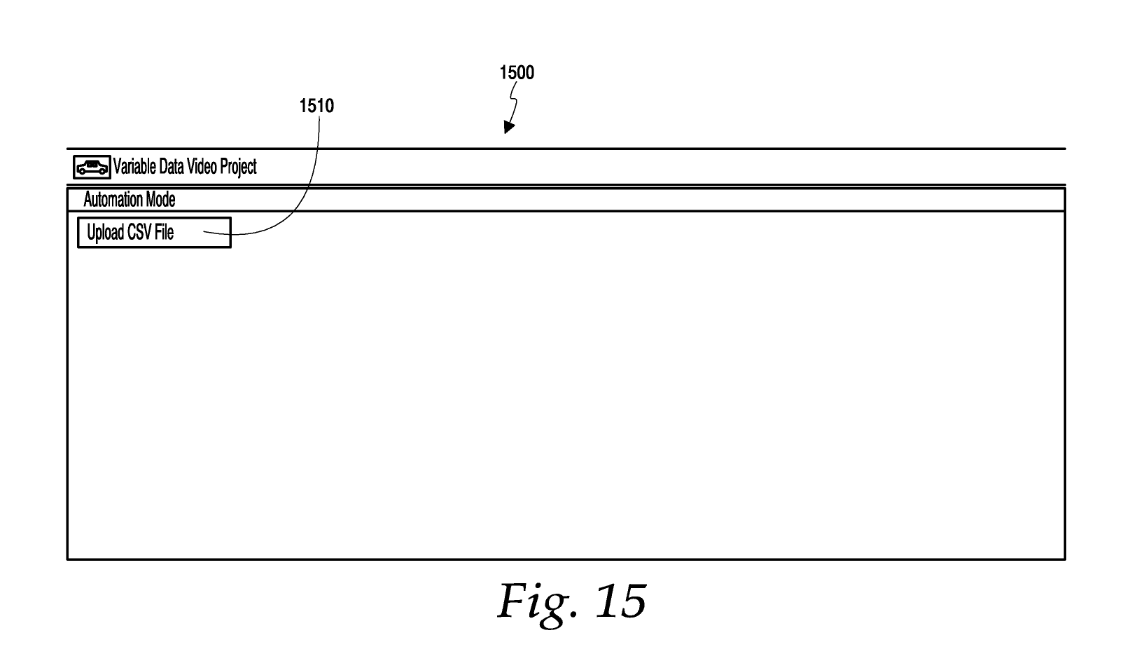

FIG. 15 presents an example user interface 1500 for importing a data file. Via interface 1500, the user may select to upload a data file by clicking on an upload icon 1510 that enables the user to select a data file for uploading. In some examples, the data file can be a spreadsheet file comprising an array of output files. In some examples, the data file can be in the form of a comma separated values file (e.g., a .csv file), which allows data to be saved in a table structured format. Converting a spreadsheet to a .csv file can allow the interface to upload the data and incorporate it into the interface described herein regardless of the format in which the spreadsheet was originally generated.

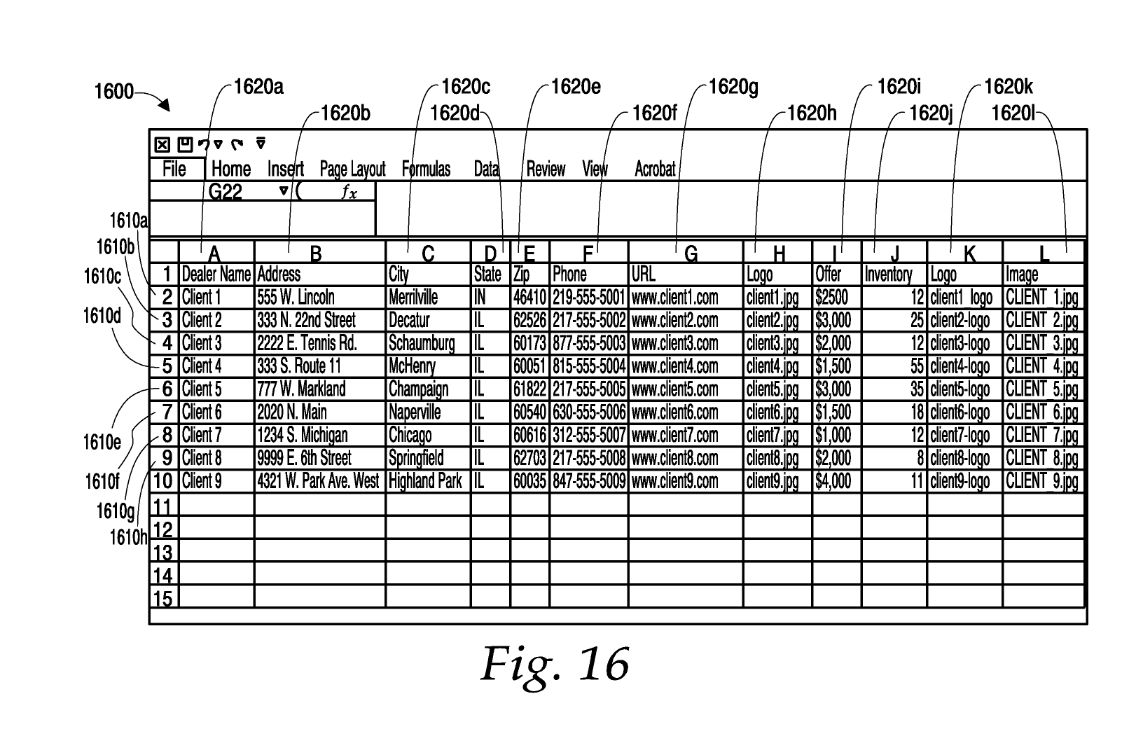

In some examples, the data file can be a spreadsheet, matrix, array, or other arrangement of data stored in a table structured format. FIG. 16 illustrates an example data file spreadsheet 1600 that can be used to generate variable data custom multi-media files over a network. The spreadsheet 1600 can include an array of rows 1610n and columns 1620n. Each of the rows 1610n provides a one-dimensional array of data to be assigned to one individual variable data video. Each of the columns 1620n provides a field or a one-dimensional array of data intended to be assigned to one particular layer used in a series of variable data videos.

The exemplary spreadsheet of FIG. 16 presents nine rows 1610 of data to be used to generate nine individual variable data videos for automobile dealerships. In this example, the independent variable data videos will present a single base video with variable data output displayed during various intervals of the video. Here, each row 1610n represents a single dealership. For instance, row 1610a represents a dealership for “Client 1.” That is, the data in row 1610a contains information (e.g., address, telephone number, etc.) associated with Client 1. In this manner, variable data videos based on row 1610a will produce overlays with unique output that is custom made for Client 1.

Each column 1620n represents a particular type of data that can be displayed in association with one or more layers. For instance, column 1620a provides the dealer name, 1620b-e provide the dealer address, city, state, and zip code. Column 1620f provides the dealer phone number. 1620g provides a website address. Column 1620h provides a particular logo for the dealer. In this column the output file is represented by “client1.jpg,” “client2.jpg,” etc. Each column represents output that can be assigned to a particular layer of a variable data video. For example, a video template may have a “logo” layer, whereby the video displays a company logo for a portion of time. When the logo column 1610h is assigned to such a layer, the output files in that column will be displayed or used to control the display of the output associated with such layer.

In some examples the spreadsheet 1600 can include a logo (e.g., as an image file) directly in the spreadsheet. Additionally and/or alternatively, the column can be associated with another file or location that facilitates in the further importation of a series of files. For instance, column 1620h may reference another file or folder stored on the requesting computer device that contains the image files (or other file types) identified in the column.

Column 1620i provides “offer” data, which can relate, for example, to the particular sale price or discount of a particular vehicle offered by the dealer that may be displayed during the video. For instance, the variable data video may demonstrate a particular vehicle for sale in the base video portion. Each of the dealers of columns 1610a-h may offer differing cash back amounts for the sale of such a vehicle.

Column 1620j presents “inventory” data, which can represent the amount of the offered sale item that is available in stock at that dealer. Columns 1620k and 1620l provide other logos and images that can be displayed during the video. For instance, these columns can provide secondary logos or slogans.

For purposes of simplicity, many references of the present disclosure refer to the “data file” as an array or spreadsheet having “rows” and “columns” that define fields, or one-dimensional arrays of data. However, it should be understood that the particular name or geometrical arrangement of these arrays is not particularly significant except for its relationship to other collections of data described in connection therewith. For example, while the present description describes the horizontal “rows” of the data file being associated with the particular videos and the vertical “columns” as being associated with the layers, some examples may assign vertical “columns” to videos and horizontal “rows” to the layers without departing from the scope of this disclosure.

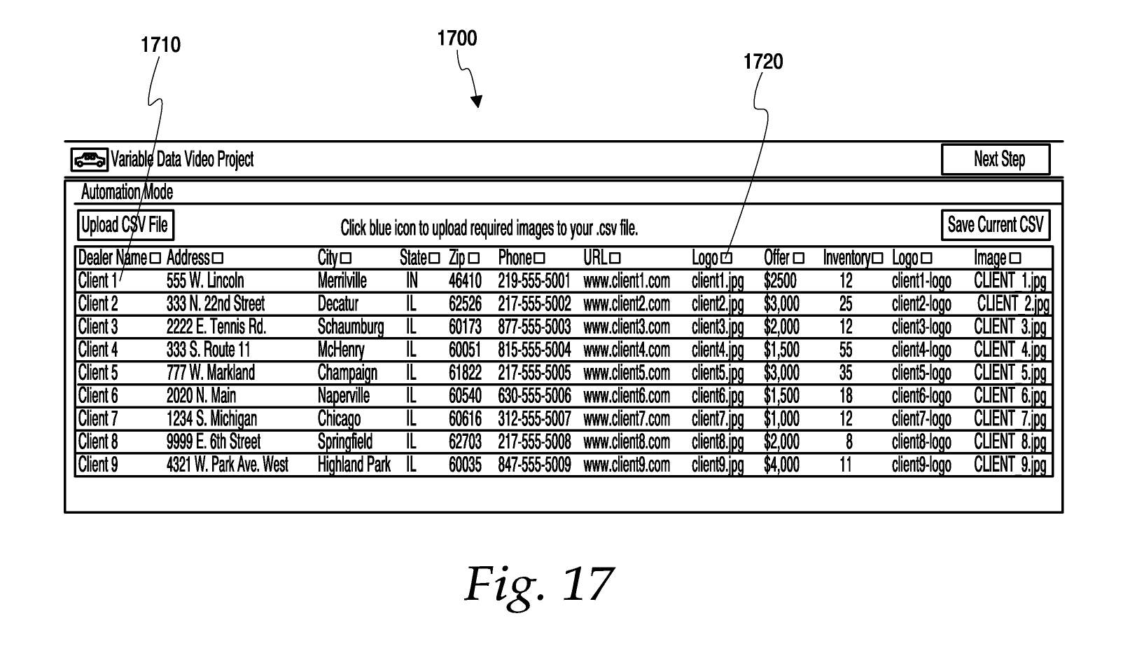

Once uploaded, the user interface may present the data file as an array or table. FIG. 17 provides an example user interface 1700 displaying an imported data file as an array of output files. The array of output files comprises a series of rows 1710 associated with an individual variable data video and a series of columns 1720 associated with a particular layer of a video template.

Via interface 1700, a user can also upload other information that is associated with a particular row or column. For instance, a particular column 1720 may be associated with a series of image files. In this manner, a user can select column 1720 by selecting the box affiliated with that row. Then, via the user interface, select a particular folder or location that contains the files identified in the column 1720. For example, after selecting the box associated with column 1720, the user interface may request the user to select a file on the local computer (or via a network) that includes the “client 1.jpg,” “client 2.jpg” files, and so forth. Upon selection of those files, the computing device can then import or upload the selected files for use in generation of the variable data videos.

Referring back again to FIG. 14, the method 1400 also provides 1420 a user interface for a requesting device to manipulate a timeline of a video template. The video template can be provided using the methods and techniques described above. For example, the method 1400 can include making a library of stored video templates available to the requesting computing device and then receiving an indication of selection of one or more videos. In other examples, the method 1400 can provide a video template automatically or import a video template from another platform. In some embodiments the user interface is designed for an efficient, user-friendly operation and presents only the particular functions and features that are applicable for the limited task or tasks operable by the interface.

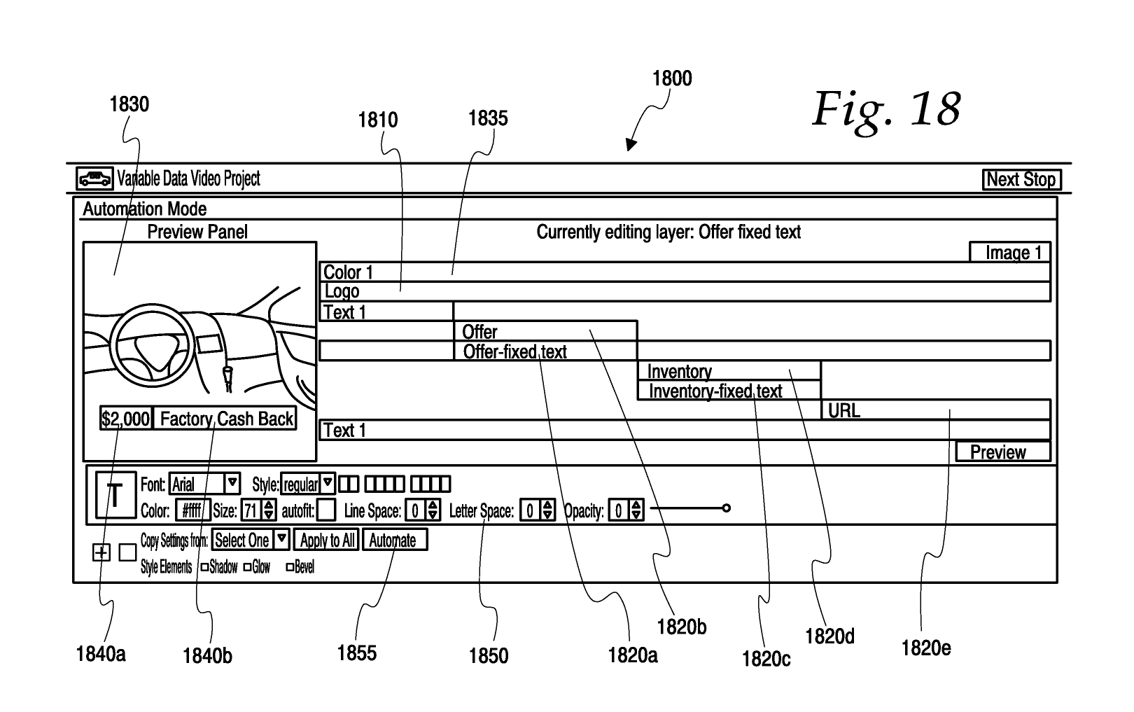

FIG. 18 illustrates an example user interface 1800 of a video template with a timeline 1810. The timeline 1810 represents the display of the video or custom multi-media file generated by the program. Along the timeline are a series of elements or layers 1820 that are associated with one or more outputs that display on the video during a period of time represented by the layer's length along the timeline 1810.

A display window 1830 shows a frame of the video represented by the location of the time marker 1835 on the timeline 1830. The display window 1830 may include one or more outputs 1840 that can appear as graphics, videos, images, text, logos, etc. In FIG. 18, which is paused at the time interval indicated by time marker 1835, two layers, 1820a and 1820b, are active. Those layers include an “offer” layer 1820a and an “offer fixed text” layer 1820b.

The offer layer 1820a can be configured to correspond to a particular offer referenced unique to each of the variable data videos. For instance, offer layer 1820 can represent the amount of cash back that a particular auto dealership is offering with respect to a certain automobile. In this manner, a user can assign the “offer” column to offer layer 1820. The offer fixed text layer 1810b can be configured to correspond to contain fixed data (as opposed to variable data) that is consistent among all of the variable data multi-media files generated by the method. For instance, the offer fixed text layer 1820b can correspond to a description of the offer being presented, while the offer layer 1820a corresponds to the amount offered as presented in each individual video. In this example, the “offer” layer 1820a corresponds to the “$2000” output graphic 1840a on the video, whereas the “offer fixed text” layer 1820b corresponds to the “factory cash back” output graphic 1840b.

In some examples, elements of a low resolution preview of a variable data video or custom multi-media file may be provided through the display window 1830. In some forms, the low resolution preview can be presented via another interface or display screen. The preview can be provided from the computing device over the network for playback at the requesting computing device. As explained above with respect to other embodiments, providing the low resolution preview can include analyzing the first custom multi-media file to build a list of required preview elements, determining capture methods for elements of the first custom multi-media file, transcoding elements of the first motion custom multi-media file to create transcoded elements to use in the low resolution preview of the first motion custom multi-media file, and then building the low resolution preview of the first full motion custom multi-media file using the transcoded elements.

In some examples, the video template can be configured to allow the requesting computing device to manipulate the elements of the low resolution preview of the variable data videos. In some examples, the manipulation can be provided by way of a modification interface 1850. The modification interface 1850 can include one or more tools for editing the layers and other aspects of the video. For example, using the modification interface 1850, a user can modify the font or other graphics associated with the layers. For example, the modification interface 1850 can allow a user to modify the font type, style, size, color, justification, spacing, opacity, centering, or the like.

The modification interface 1850 can also allow modification of the size, type, style, etc. of the graphics, images, videos, or other outputs displayed via the layer. Through the modification interface 1850, a user may also modify the duration of the layers or their position on the time line. In some forms a user may also be able to add new layers or delete unwanted layers via the modification interface 1850. In some approaches, the modification interface 1850 allows a user to assign graphics or output files to the layers.

The modification interface 1850 can be configured to present only functionality and tools that are available for use in the present situation. Because the presently described programs and methods are capable of being performed over a network, the applications can control and/or limit the functionality available to the user. This can help limit the amount of local resources the application requires on the local requesting computing device, and it can also make the application more user friendly, as the user will not need to search for functionality that is applicable for the task at hand.

Referring again to FIG. 14, method 1400 also includes receiving 1430 a request to assign an array of output files to one or more layers of the template. This receiving 1430 can be received in response to a user operating the modification interface 1850 of FIG. 18. For example, the user may be able to select a spreadsheet column from the imported data file to a layer. In response, the computing device can generate a distinct video for each item (e.g., each spreadsheet row) in the data file using the output file in the selected column to generate the output associated with that layer. In some examples, the user can achieve this functionality by selecting the automate button 1855. Selecting this automate button 1855 can bring up a pulldown menu that lists each of the columns of the imported data file. In selecting one or more of the columns, the application thus assigns the data in the output files of that selected column to the selected layer to generate variable data videos (i.e., variable data custom multi-media files).

In some embodiments, the method 1400 includes receiving requests to assign an array to just one layer of the video template. For instance, the variable data videos may include only one layer that is custom fit for each of the files. In this manner, only one layer may be assigned to a column from the data file, and the other layers in the template timeline (if any) will be associated with fixed data (i.e., the layers will be the same for each custom multi-media file). Alternatively, the method 1400 can include receiving requests to assign two or more layers with one or more columns from the data file. This will allow the custom multi-media files to display multiple outputs that are unique to each video. For instance, one layer may display a dealer name, another layer may display a dealer address, another may display a dealer logo, etc.

Referring again to the flow diagram of FIG. 14, the method 1400 can then process 1440 data files to generate variable data custom multi-media files (e.g., variable data videos). The processing 1440 can be based on the data file and the requests to assign columns, or arrays as described above with respect to step 1430. For example, the method 1400 can assign the output files to the layers of the template as selected by the user via the interface as described above.

In some examples, a user can select to process custom multi-media files for each item in the data file. Alternatively, a user can select only a portion of the items. For example, the user can select which of the items (represented in by rows) in the data file for processing as custom multi-media files. In examples where only one item from the data file is selected, the processing 1440 can include generating a first custom multi-media file. In further examples where two or more data file items are selected, the processing 1440 can include generating custom multi-media files for each selected item.

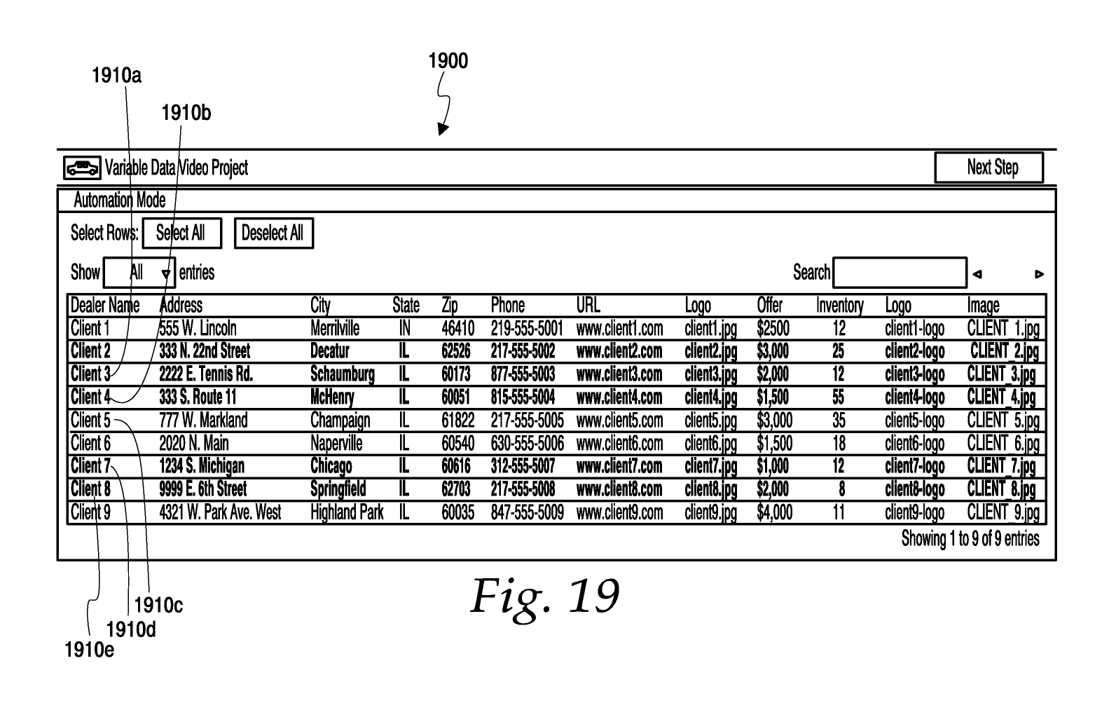

FIG. 19 comprises an illustration of an example user interface 1900 that allows a user to assign arrays of output files (e.g., spreadsheet rows) from the data file to variable data custom multi-media files invention. For example, FIG. 19 shows that a user has selected five rows (1910a-e) for processing. Accordingly, in this example, the method will process custom multi-media files for each of the selected rows. That is, in this example, custom multi-media files will be processed for the dealers identified as client 3, client 4, client 5, client 7, and client 8.

In generating the custom multi-media files, the method 1400 can include gathering elements of the custom multi-media file (e.g., the output files assigned to the layers), rendering individual frames of the first custom multi-media file, and then saving the individual frames as an image sequence. In some examples, the method 1400 will encode the image sequence together into the first custom multi-media file.

In some embodiments, the method 1400 then makes available 1450 variable data custom multi-media files (e.g., videos) to a user. The custom multi-media files, when played, can display the outputs that are based, at least in part, on the output files that are assigned to the layers of the template timeline. In examples where only one item from the data file is selected, the method 1400 makes available the one custom multi-media file associated with that selected item. In further examples where two or more data file items are selected, the method 1400 can make available each of the processed custom multi-media files. Because the columns assigned to the layers of the template contain information that may be unique to each custom multi-media file, the output displayed over the time periods associated with the layers can differ, at least among some of the generated custom multi-media files.

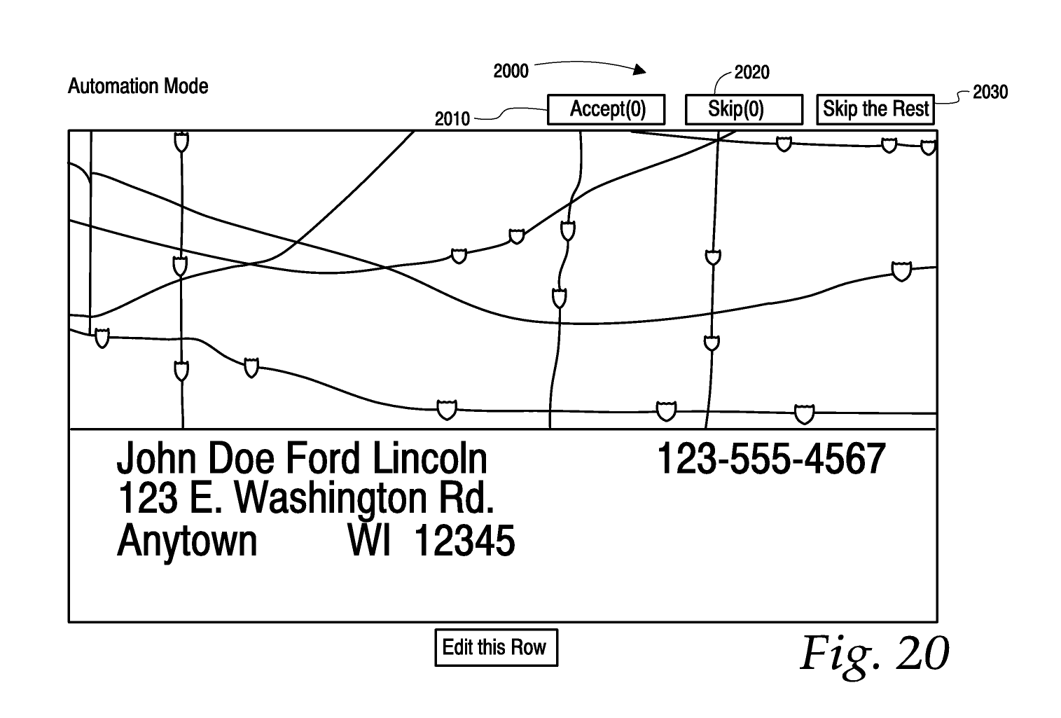

FIG. 20 comprises an illustration of an example user interface 2000 displaying a preview of one variable data custom multi-media file. In this preview, the interface 2000 shows a frame from the custom multi-media file that displays an output of a map associated with one item (e.g., one client) from the data file. Via this interface 2000, the user can accept the custom multi-media file by selecting button 2010 or skip the file (e.g., so that the file can be further processed and edited) by selecting skip button 2020. In some examples, selecting either the accept button 2010 or the skip button 2020 will advance the preview interface 2000 to the next variable data custom multi-media file. Alternatively, the user can elect to skip the remaining videos by selecting the skip the rest button 2030 and continue to edit and/or revise the remaining un-accepted files.

In some examples, before the method 1400 makes available the variable data custom multi-media files to the user, the method will wait to receive a payment from the user using any of the techniques and methods described herein. For example, the computing device may provide signals to the requesting computing device to effect presentation of media available for purchase from third parties over an internet-based transaction. In other words, a user interface is provided, for example, through a web browser or through another computer based application, such that a user desiring to create variable data custom multi-media files can access a library of video templates to use in creating the user's custom file.

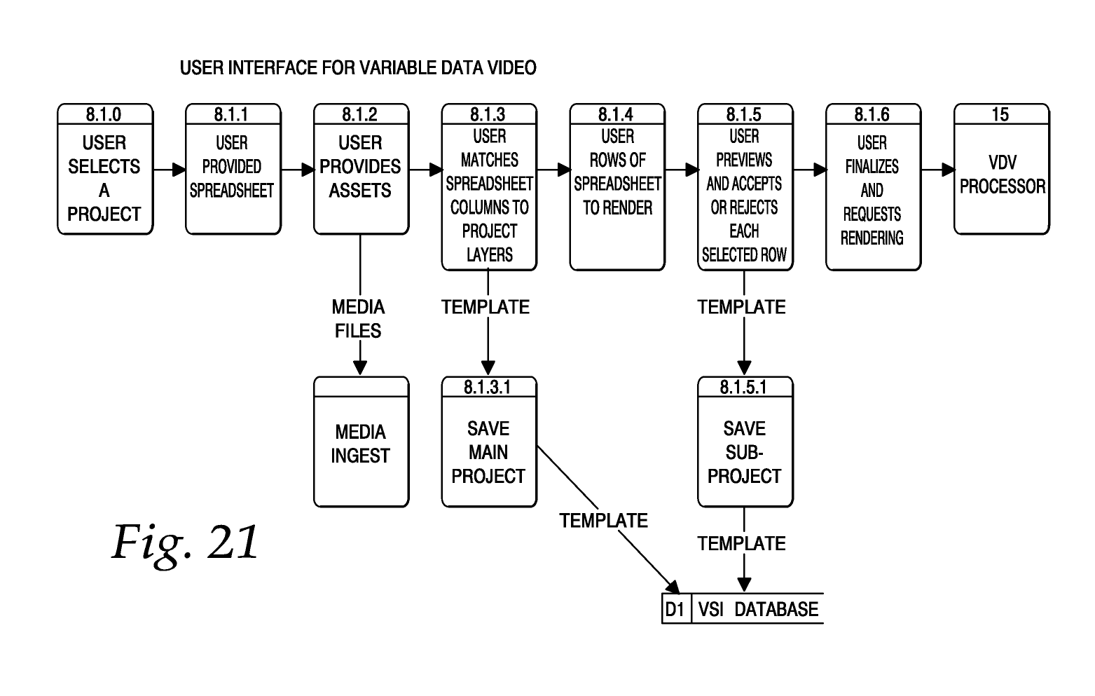

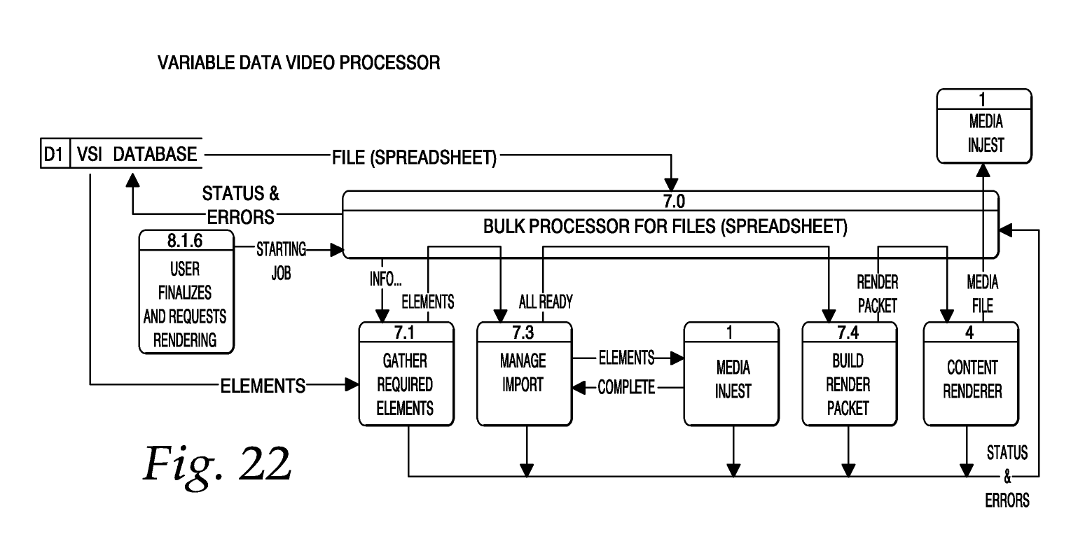

FIGS. 21 and 22 present block diagrams that demonstrate in more detail certain aspects of a method for generating variable data custom multi-media files. FIG. 21 comprises a block diagram that steps through one example of a variable data video generation process from the perspective of a user interface. The user interface is configured to allow a user to select a project 8.1.0. For example, the user may select a video template in accordance with any of the techniques disclosed herein. In some examples, the user interface can make a library of stored video templates available to the requesting computing device and then receiving an indication of selection of one or more videos.

Next, a user operating a requesting computing device provides a spreadsheet 8.1.1. For example, a user can import or upload, either from the requesting computing device itself or another device (e.g., through a cloud-based account or via a device accessible through a network), a spreadsheet or a data file that comprises an array of information. The user can also provide assets 8.1.2, such as image files, video files, sound files, text files, or other media files that are associated with the information in the spreadsheet, which are then ingested by the computing device.

Next, the user matches 8.1.3 the spreadsheet columns to project layers of a video template, and saves 8.1.3.1 the template to a database D1 associated with the computing device. For example, the user may assign one or more columns from the imported spreadsheet to one or more layers of the video template. In this manner the assigned files of the spreadsheet will be affiliated with the layers so that the video displays the output files (or other data based at least in part on the output files) over time periods that correspond with the placement of the associated layers on the timeline of the video template.

Next, a user selects rows 8.1.4 of the spreadsheet to render. For each row of the spreadsheet, the computing device will generate an independent variable data video. In some examples a user can select only one row, thereby generating only one video. In other embodiments a user can select some or all of the spreadsheet rows, thereby resulting in the generation of multiple variable data videos.

The user can then preview 8.1.5 and accept or reject the videos affiliated with each selected row. An example of such a preview is shown in FIG. 20 and described above. Once accepted, the video is saved 8.1.5.1 as a sub-project in the database D1.

The user can then finalize 8.1.6 the video and request rendering of the video. In response to the request to render, a variable data video processor 15 will process the files to generate one or more variable data videos.

FIG. 22 comprises a block diagram showing an example approach for processing variable data video from the perspective of a variable data video processor. The processor processes a data file from a user provided source and injects the file into a user video composition. The composition is then copied and edited for each version and then transmitted to a rendering processor for final production.

The example approach of FIG. 22 picks up from the process of FIG. 21. That is, FIG. 22 shows a more detailed view of the components and operation of the VDV (variable data video) processor 15 of FIG. 21. In response to the user finalizing and requesting rendering 8.1.6, bulk processor 7.0 processes information from the database D1, which can comprise information provided via the user interface via the process of FIG. 21. For instance, the bulk processor 7.0 can execute a process 7.1 for gathering elements of the video that can include media files associated with the output files of the spreadsheet assigned to layers of the video template.

The bulk processor 7.0 also includes a manage import process 7.3 that manages ingest of gathered elements into the variable data videos via a media ingest process 1. In some examples the bulk processor 7.0 also includes a bulk render packet process 7.4 that renders packets of variable data videos and also renders the videos via a content render process 4. In some examples, the rendered videos are then processed via the media ingest process 1.

An example operation of the variable data video generation process will now be described as an example of operation in connection with one example of a network based video creation platform described herein. The process initially involves importing spreadsheet or data file as a .csv file. For example, a user can create a spreadsheet in a spreadsheet application (e.g., Microsoft Excel) on a requesting computing device and save that spreadsheet as a .csv file using the application's “save as” feature. The spreadsheet can either be saved locally on the requesting computing device or on some other storage medium accessible from the requesting computing device (e.g., a cloud account).

Via a user interface provided by the platform, a user will first select a template that will be used to generate the variable data videos. In some embodiments, if desired, the user can modify the template, for example, by adjusting the position and duration of the layers throughout the timeline of the template. A user may optionally provide names to the layers, however, the user can also use the default names provided by the program.

At this point of the example, the template layers are ready for ingest. The project can thus be renamed and saved to a project bin for access and editing at a later date. Next, a user selects an option to generate variable data video. For example, a user can click on a “my projects” operation via a pull down menu on the interface and select variable data video as the operation.

Next, the requesting computing device will export the .csv file to a computing device via a network. This can be accomplished by selecting an “upload” feature on a user interface operated on the requesting computing device, for example, through a browser. In some examples, some of the items in the uploaded spreadsheet will reference other media files, such as image files, video files, sound files, etc. In such an example, a user may be able to upload the files referenced in the spreadsheet. When the spreadsheet and related date have been uploaded, the user can select next and proceed to the next step of the operation.

Next, a user assigns some or all of the layers in the template to corresponding columns from the imported spreadsheet by clicking, for example, an “automate” button. When the layers are assigned, a user can click a “next step” button, where specific rows of the spreadsheet can be selected for rendering. In some instances, the user can simply elect to render all rows.

Next, the interface will show a preview of each of the videos for the user to review before selecting to render. Each video can have unique images associated with the business or entity associated with the video. The video can include, for example, a unique offer, a unique map, a unique logo, and so on. The user can elect to accept the videos or proceed to further process, revise, edit, or otherwise modify the videos.

Eventually, the user can select a “render” option via the user interface. Upon selecting to render, the platform can process payment information and transmit an email or other type of communication confirming the order to the user. In some embodiments, the platform will transmit another communication to the user when the rendered videos are ready for download. The power of this automation process is that it will work for as few or as many distinct records you have in your database.

In some examples, the rendered videos can be directly transmitted over a network to a displaying computing device. For example, where the user created multiple variable data videos with the intention that each variable data video be displayed at a different location (e.g., at a different auto dealership), the videos can then be directly exported to computing devices affiliated with each dealership. In this manner, each dealership can then access and display the rendered videos as appropriate.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept. In addition, it should be understood that features of one embodiment disclosed herein may be combined with features of other embodiments to provide yet other embodiments as desired.

What is claimed is:

1. A method comprising:
receiving by a computing device over a network a data file comprising at least one array of output files;
providing a user interface for a requesting computing device to manipulate a video template, the user interface allowing the requesting computing device to send signals effecting editing of the video template to create a custom multi-media file, the user interface providing at least one layer on a timeline;
receiving a request to assign a first array of output files from the data file to a first layer of the least one layer on the timeline, the first layer associated with display of an output during a first time period of a custom multi-media file, the first array of output files comprising a first output file;
processing the data file and the request with the computing device to generate a first custom multi-media file; and
making available the first custom multi-media file to the requesting computing device,
wherein the first custom multi-media file displays an output over the first time period that is based at least in part on the first output file.

2. The method of claim 1, wherein the first array of output files comprises a second output file,
wherein the processing further includes generating a second custom multi-media file,
wherein the making available further comprises making the second custom multi-media file available to the requesting computing device, and
wherein the second custom multi-media file displays an output over the first time period that is based at least in part on the second output file.

3. The method of claim 1, wherein the receiving a request further includes receiving a request to assign a second array of output files from the data file to a second layer of the least one layer of the timeline, the second layer associated with the display of an output during a second time period of a custom multi-media file, the second array of output files including a third output file and a fourth output file,
wherein the processing further includes generating a second custom multi-media file,
wherein the making available further comprises making the second custom multi-media file available to the requesting computing device,
wherein the first custom multi-media file displays an output over the second time period that is based at least in part on the third output file, and
wherein the second custom multi-media file displays an output over the second time period that is based at least in part on the fourth output file.

4. The method of claim 1, wherein the output file comprises at least one of a text file, a video file, an image file, or an audio file.

5. The method of claim 1, further comprising providing elements of a low resolution preview of the first custom multi-media file from the computing device over the network for playback at the requesting computing device, the template configured to allow the requesting computing device to manipulate the elements of the low resolution preview of the first custom multi-media file.

6. The method of claim 5, wherein the providing the low resolution preview of the first custom multi-media file comprises:
analyzing the first custom multi-media file to build a list of required preview elements;
determining capture methods for elements of the first custom multi-media file;
transcoding elements of the first motion custom multi-media file to create transcoded elements to use in the low resolution preview of the first motion custom multi-media file; and
building the low resolution preview of the first full motion custom multi-media file using the transcoded elements.

7. The method of claim 1, wherein the receiving the data file includes importing the data file over the network via the requesting computing device.

8. The method of claim 1, further comprising:
receiving by the computing device over the network a request from the requesting computing device to create a variable data video custom multi-media file; and
making a library of stored video templates available to the requesting computing device by:
receiving a media packet from a media providing computing device;
processing the media packet with the computing device to determine errors in the media contained in the media packet;
processing the media packet with the computing device to extract metadata associated with the media packet;
processing the media packet with the computing device to extract assets other than the media from the media packet; and
storing the media, metadata, and assets in a storage device configured to make the media available to the requesting computing device in accord with the metadata.

9. The method of claim 1, wherein generating a first custom multi-media file comprises:
gathering elements of the first custom multi-media file;
rendering individual frames of the first custom multi-media file;
saving the individual frames as an image sequence; and
encoding the image sequence together into the first custom multi-media file.

10. The method of claim 1, further comprising
receiving information relating to purchase credentials relating to the first custom multi-media file;
in response to the receiving the information relating to purchase credentials, making available the first full motion custom multi-media file to the requesting computer device.

11. A method of generating variable data custom multi-media files, the method comprising:
receiving by a computing device over a network a data file comprising an array of output files;
providing a user interface for a requesting computing device to manipulate a video template, the user interface allowing the requesting computing device to send signals effecting editing of the video template to create variable data custom multi-media files, the user interface providing at least one layer on a timeline, each layer on the timeline being associated with display of an output during a time period of the variable data custom multi-media files;
receiving a request to assign a first column from the array of output files to a first layer of the at least one layer on the timeline, the first layer associated with the display of an output during a first time period of a variable data custom multi-media file;
processing the data file and the request with the computing device to generate variable data custom multi-media files; and
making available the variable data custom multi-media files to the requesting computer device,
wherein each of the variable data custom multi-media files displays an output over the first time period that is based at least in part on an individual output file from the first column of the array of output files, and wherein at least two of the variable data custom multi-media files display a different output during the first time period.

12. The method of claim 11, wherein the receiving a request further includes receiving a request to assign a second column from the array of output files to a second layer of the least one layer on the timeline, the second layer associated with display of an output during a second time period of the variable data custom multi-media files,
wherein each of the plurality of custom multi-media files displays an output over the second time period that is based at least in part on an individual output file from the second column of the array of output files, and wherein at least two of the custom multi-media files display a different output during the second time period.

13. The method of claim 11, wherein the output file comprises at least one of a text file, a video file, an image file, or an audio file.

14. The method of claim 11, further comprising providing elements of a low resolution preview of the variable data custom multi-media files from the computing device over the network for playback at the requesting computing device, the template configured to allow the requesting computing device to manipulate the elements of the low resolution preview of the variable data custom multi-media files.

15. The method of claim 14, wherein the providing the low resolution preview of the variable data custom multi-media files comprises:
analyzing the variable data custom multi-media files to build a list of required preview elements;
determining capture methods for elements of the variable data custom multi-media files;
transcoding elements of the variable data custom multi-media files to create transcoded elements to use in the low resolution preview of the variable data custom multi-media files; and
building the low resolution preview of the variable data custom multi-media files using the transcoded elements.

16. The method of claim 11, wherein the receiving the data file includes importing the data file over the network via the requesting computing device.

17. The method of claim 11, further comprising:
receiving by the computing device over the network a request from the requesting computing device to create a variable data video custom multi-media file; and
making a library of stored video templates available to the requesting computing device by:
receiving a media packet from a media providing computing device;
processing the media packet with the computing device to determine errors in the media contained in the media packet;
processing the media packet with the computing device to extract metadata associated with the media packet;
processing the media packet with the computing device to extract assets other than the media from the media packet; and
storing the media, metadata, and assets in a storage device configured to make the media available to the requesting computing device in accord with the metadata.

18. The method of claim 11, wherein generating variable custom multi-media files comprises:
gathering elements of the variable data custom multi-media files;
rendering individual frames of the variable data custom multi-media files;
saving the individual frames as an image sequence; and
encoding the image sequence together into the variable data custom multi-media files.

19. The method of claim 11, further comprising
receiving information relating to purchase credentials relating to the variable data custom multi-media files;
in response to the receiving the information relating to purchase credentials, making available the variable data custom multi-media files to the requesting computer device.

20. An apparatus comprising:
a computing device connected to a network to receive signals from a requesting computing device;
a storage device configured to store video templates;
a storage device configured to store a modified video template as a series of variable data custom multi-media files;
wherein the computing device is configured to:
receive a data file comprising an array of output files over a network;
provide a user interface for a requesting computing device to manipulate a video template, the user interface allowing the requesting computing device to send signals effecting editing of the video template to create variable data custom multi-media files, the user interface providing at least one layer on a timeline, each layer on the timeline being associated with the display of an output during a time period of the variable data custom multi-media files;
receive a request to assign a first column from the array of output files to a first layer of the at least one layer on the timeline, the first layer associated with display of an output during a first time period of a variable data custom multi-media file;
process the data file and the request to generate variable data custom multi-media files; and
make available the variable data custom multi-media files to the requesting computing device,
wherein each of the variable data custom multi-media files displays an output over the first time period that is based at least in part on an individual output file from the first column of the array of output files, and wherein at least two of the variable data custom multi-media files display a different output during the first time period.
